(19) United States
(12) Patent Application Publication
(10) Pub. No.: US 2025/0263223 A1
(43) Pub. Date: Aug. 21, 2025

(54) ARRAY OF PEST CONTROL PRODUCTS

(71) Applicant: The Procter & Gamble Company, Cincinnati, OH (US)

(72) Inventors: Michael David O'Young MUI, Mason, OH (US); Travis Kyle HODGDON, Cincinnati, OH (US)

(21) Appl. No.: 19/055,598

(22) Filed: Feb. 18, 2025

Related U.S. Application Data
(60) Provisional application No. 63/555,524, filed on Feb. 20, 2024.

(51) Int. Cl. B65D 83/141; A01N 25/06; A01P 13/00; A01P 17/00

(52) U.S. Cl. CPC B65D 83/141; A01N 25/06; A01P 13/00; A01P 17/00

(57) ABSTRACT

An array of pesticidal products that includes at least a first pesticidal product that may be stored and/or used in an inverted orientation and a second pesticidal product that may be stored and/or used in an upright orientation.

### CROSS REFERENCE TO RELATED APPLICATIONS

This application claims the benefit, under 35 U.S.C. § 119 (e), to U.S. Provisional Application No. 63/555,524, filed Feb. 20, 2024, the entire disclosure of which is fully incorporated by reference herein.

### FIELD

The present disclosure relates to pest control products and arrays of pest control products, which are designed to manage different species of pests that inhabit different environments, to provide a range of targeted products that effectively address all of a consumer's pest control needs.

### BACKGROUND

A large number of pest control products exist today, including products for controlling weeds and products for controlling arthropod pests. Moreover, the market for pest control products is growing, due to factors such as a growing consumer awareness concerning health and hygiene, changes in weather patterns, an increase in home food gardening, and the desire to keep lawns, flower beds, etc. looking neat and attractive. As the number of pest control product offerings increases to meet the demand, it becomes more difficult for a consumer to navigate store shelves and select the best product for his or her specific needs.

Consumers of pest control products, for example insect control products, currently have the opportunity to purchase products that are targeted at a particular pest, such as an ant, but differ in physical form and/or application. For example, ant control products are currently offered in physical forms that range from liquid sprays that kill ants to solid pellets that repel ants. In addition, some currently marketed ant control products are marketed specifically for indoor use, others are marketed specifically for outdoor use, and some are marketed for both indoor and outdoor use. Thus, the number of product offerings for ants alone can be difficult to navigate for the average consumer. For consumers that need to address multiple pest control needs, such as ants and fruit flies inside the kitchen, wasps living under a deck, or weeds growing in a vegetable garden, the number of product offerings can be overwhelming. Moreover, though consumers may seek out a range of pest control products, each targeted for a specific need, consumers may also desire that the range of products share a common characteristic, such as products that contain natural or recognizable ingredients. It may be challenging for consumers to identify products intensive properties, especially what dominant intensive properties a pest control product exhibits when the consumer is viewing multiple pest control products as they are displayed on a store shelf at the time the consumer is making a purchasing decision.

Furthermore, it is believed that the longer it takes for a consumer to identify a product on the store shelf, the less likely they will be to select and evaluate their intended product for subsequent purchase while in the store. This delay time in identifying the appropriate product on the store shelf can affect both initial purchase and/or repurchase intent of a particular product, even if the consumer has used and liked the performance of the product in the past.

However, conventional pest control products, packaging and marketing strategies utilized by producers of these products fail to satisfy consumers' desires.

Accordingly, there is a need for pest control products, for example pest control products that are associated with non-textual indicia that are psychologically matched to intensive properties of the pest control products, which may simplify and/or expedite a consumer's identification and/or selection process of pest control products on a store shelf and thus, reduce consumer confusion, shopping time and/or overall dissatisfaction with the shopping process, processes for making such pest control products, and marketing articles associated with displaying or advertising such pest control products. There is also a need to provide pest control products that are intuitive to use, as well as for arrays of pest control products that make selection of an appropriate product for a specific application more intuitive.

The discussion of shortcomings and needs existing in the field prior to the present disclosure is in no way an admission that such shortcomings and needs were recognized by those skilled in the art prior to the present disclosure.

### SUMMARY

An array of pesticidal products comprising:
a. a first pesticidal product comprising an aerosol container comprising a reservoir, an actuator assembly comprising a resting plane such that the first pesticidal product may be shelved in an inverted orientation, and a first pesticidal composition stored within the first pesticidal product reservoir; and
b. a second pesticidal product comprising a container comprising a reservoir, a nozzle and a second pesticidal composition stored within the second pesticidal product reservoir, wherein the second pesticidal product is shelved in an upright orientation.

These and other features, aspects, and advantages of various embodiments will become better understood with reference to the following description, figures, and claims.

### BRIEF DESCRIPTION OF THE DRAWINGS

Many aspects of this disclosure can be better understood with reference to the following figures, which provide non-limiting examples of various embodiments.

FIG. 1A is a schematic illustration of a consumer viewing a store shelf containing various arrays of products.

FIG. 1B is a schematic illustration of a consumer viewing a display containing various arrays of products.

FIG. 2 is a schematic illustration of an array of products.

FIG. 3 is a front view of an aerosol dispensing device in an unlocked configuration, resting on a support surface.

FIG. 4 is a bottom perspective view of an aerosol dispensing device.

FIG. 5 is a bottom perspective view of an aerosol dispensing device with the actuator depressed.

FIG. 6 is a partially exploded view of an aerosol dispensing device, showing an aerosol container and an undercap.

FIG. 7 is a front perspective view of an aerosol container with an aerosol stem displacing an aerosol valve to a closed position.

FIG. 8 is a front perspective view of an aerosol container with an aerosol stem displacing an aerosol valve to an open position.

FIG. 9 is a front, cross-sectional view along line A-A in FIG. 7 of an aerosol container comprising a check valve and a dip tube, in an inverted orientation.

FIG. 10 is a front, cross-sectional view along line A-A in FIG. 7 of an aerosol container comprising a check valve and a dip tube, in an upright orientation.

FIG. 11 is a side view of an undercap.

FIG. 12 is a back view of an undercap.

FIG. 13 is a cross-sectional view along line B-B in FIG. 11 of an undercap.

FIG. 14 is a cross-sectional view along line C-C in FIG. 12 of an undercap.

FIG. 15 is a cross-sectional view along line C-C in FIG. 12 of an undercap with the actuator depressed.

FIG. 16 is a schematic illustration of a first type of product shelved in an upright orientation.

FIG. 17 is a schematic illustration of a second type of product shelved in an upright orientation.

FIG. 18 is a schematic illustration of a third type of product shelved in an upright orientation.

It should be understood that the various embodiments are not limited to the examples illustrated in the figures.

### DETAILED DESCRIPTION

### Introduction and Definitions

This disclosure is written to describe the invention to a person having ordinary skill in the art, who will understand that this disclosure is not limited to the specific examples or embodiments described. The examples and embodiments are single instances of the invention which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and embodiments only, and is not intended to be limiting, since the scope of the present disclosure will be limited only by the appended claims.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features. The examples and embodiments described herein are for illustrative purposes only and that various modifications or changes in light thereof will be suggested to the person having ordinary skill in the art and are to be included within the spirit and purview of this application. Many variations and modifications may be made to the embodiments of the disclosure without departing substantially from the spirit and principles of the disclosure. All such modifications and variations are intended to be included herein within the scope of this disclosure. For example, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

All numeric values are herein assumed to be modified by the term “about,” whether or not explicitly indicated. The term “about” generally refers to a range of numbers that one of skill in the art would consider equivalent to the recited value (for example, having the same function or result). In many instances, the term “about” may include numbers that are rounded to the nearest significant figure.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a support” includes a plurality of supports. Particularly when a single countable noun is listed as an element in a claim, this specification will generally use a phrase such as “a single.” For example, “a single support.”

Unless otherwise specified, all percentages indicating the amount of a component in a composition represent a percent by weight of the component based on the total weight of the composition. The term “mol percent” or “mole percent” generally refers to the percentage that the moles of a particular component are of the total moles that are in a mixture. The sum of the mole fractions for each component in a solution is equal to 1.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

In this specification and in the claims that follow, reference will be made to a number of terms that shall be defined to have the following meanings unless a contrary intention is apparent.

“Intensive properties,” in the context of pest control products, refers to the inherent characteristics of these products that remain constant regardless of the quantity used. This may include the efficacy of the product in controlling pests, its toxicity level to pests and non-target organisms, and its fundamental chemical properties like pH, boiling point, or solubility. These properties define the product's inherent ability to affect pests, its potential to cause harm, and its chemical behavior, independent of how much of the product is applied.

“Standard temperature and pressure” generally refers to 25° C. and 1 atmosphere. Standard temperature and pressure may also be referred to as “ambient conditions.” Unless indicated otherwise, parts are by weight, temperature is in ° C., and pressure is at or near atmospheric.

“Disposed on” refers to a positional state indicating that one object or material is arranged in a position adjacent to the position of another object or material. The term does not require or exclude the presence of intervening objects, materials, or layers.

“Disposed within” refers to a positional state indicating that one object or material is arranged in a position partially or completely surrounded by another object or material. The term does not require or exclude the presence of intervening objects, materials, or layers.

“Align” or “aligned” or “aligning” means to place or to arrange in a straight line. Aligning edges of substrates, therefore, means arranging the substrates so that the edges in question extend along approximately the same line. It is to be appreciated that aligning edges of substrates can be accomplished in a variety of ways, including placing the substrates one on top of the other or side by side.

“Longitudinal axis” refers to an imaginary line running down the center of a body along its longest dimension.

“Direction of gravity” refers to the orientation or path along which gravity acts on an object or in a given space.

“Downward direction” refers to a direction that is substantially in or aligned with the direction of gravity.

“Upward direction” refers to a direction that is substantially opposed to the direction of gravity.

“Upright orientation” refers to a position or an alignment of a dispensing device in which the device dispenses a spray in an upward direction.

“Inverted orientation” refers to a position or an alignment of a dispensing device in which the device dispenses a spray in a downward direction.

“Multidirectional” refers to the ability of a dispensing device to dispense its contents effectively in various orientations. This includes not only an upright position, an inverted position but also sideways, or at any other angle, without noticeable loss of performance or function. This feature ensures consistent spray output regardless of the device's alignment, providing greater flexibility, targeting accuracy, and convenience to the user.

“Above” refers to a relative position of a first object or a first portion of an object in reference to a second object or a second portion of an object, in which a line extending from the first object toward the second object or from the first portion toward the second portion extends in a downward direction. In such an orientation, the first object is above the second object.

“Below” refers to a relative position of a first object or a first portion of an object in reference to a second object or a second portion of an object, in which a line extending from the first object toward the second object or from the first portion toward the second portion extends in an upward direction. In such an orientation, the first object is below the second object.

“Distal” is used to describe a location or position that is situated farther away from a point of reference or origin.

“Proximal” is used to describe a location or position that is situated closer to a point of reference or origin.

“Top” refers to a portion of a dispensing device or a component thereof that is distal to a point at which the spray exists the device. The term “top” is, therefore, most clear when the dispensing device is in an inverted orientation. Thus, the term “top” as used herein may be replaced with the term “distal” as helpful to improve clarity. In the context of arrays of products, the term “top” refers to a portion of the array that is distal to a resting plane upon which the array is disposed or upon which the array is depicted as being disposed.

“Bottom” refers to a portion of a dispensing device or a component thereof that is proximal to a point at which the spray exists the device. The term “bottom” is, therefore, most clear when the aerosol dispensing device is in an inverted orientation. Thus, the term “bottom” as used herein may be replaced with the term “proximal” as helpful to improve clarity. In the context of arrays of products, the term “bottom” refers to a portion of the array that is proximal to a resting plane upon which the array is disposed or upon which the array is depicted as being disposed.

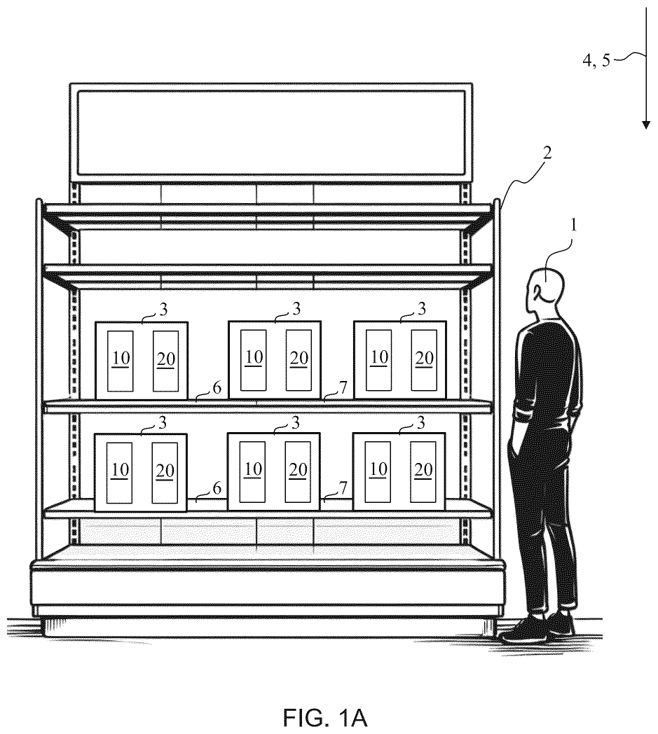

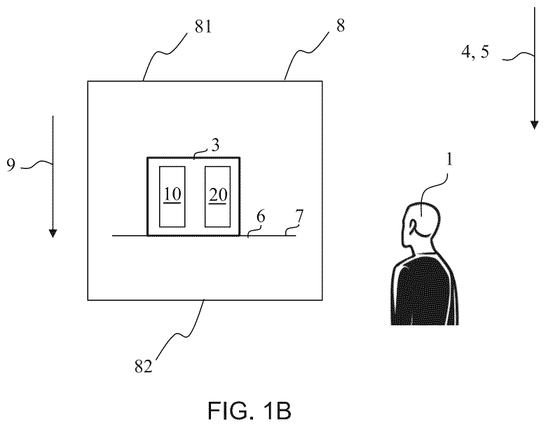

FIG. 1A is a schematic illustration of a consumer 1 viewing a store shelf 2 containing a plurality of arrays 3. Each array 3 comprising a first pesticidal product 10 and a second pesticidal product 20. The first product 10 and the second product 20 may be the same or different. The first product 10 may be a pesticidal product or an herbicidal product. Similarly, the second product 20 may be a pesticidal product or an herbicidal product. The first product 10 and the second product 20 may vary in packaging elements, composition, or both. FIG. 1A also indicates a generally downward direction 4, which substantially corresponds with or that is substantially parallel to a direction of gravity 5. The store shelf 2 may comprise one or more supporting surfaces 6, each providing a resting plane 7 for the array(s) 3. The resting plane 7 may be a plane upon which the array may be stably situated for display to the consumer 1. The resting plane 7 may extend orthogonally relative to the generally downward direction 4 and/or relative to the direction of gravity 5.

FIG. 1B is a schematic illustration of a consumer 1 viewing a display 8, showing at least one array 3. Each array 3 comprising a first product 10 and a second product 20. The first product 10 and the second product 20 may be the same or different. The first product 10 may be a pesticidal product or an herbicidal product. Similarly, the second product 20 may be a pesticidal product or an herbicidal product. FIG. 1B also indicates a generally downward direction 4, which substantially corresponds with or that is substantially parallel to a direction of gravity 5. The display 8 may be aligned with a direction 9, which may extend from a top 81 to a bottom 82 of the display 8. The direction 9 may be substantially aligned with the generally downward direction 4 or may be at an angle thereto, for example, when the display 8 is part of a kiosk and is inclined at an upwardly facing angle to allow the consumer 1 to tilt their head down to review the information on the display 8. The display 8 may include a depiction of one or more supporting surfaces 6, each providing a resting plane 7 for the array(s) 3. The resting plane 7 may be a plane upon which the array may be stably situated for display to the consumer 1. The resting plane 7 may extend orthogonally relative to the direction 9.

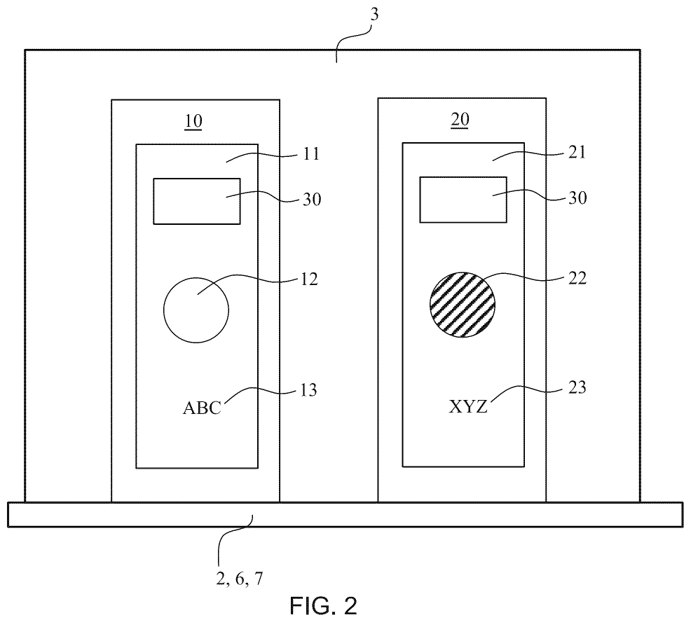

FIG. 2 is a schematic illustration of an array 3 comprising a first product 10 and a second product 20. The first product 10 may comprise markings 11. Similarly, the second product 20 may comprise markings 21. The various features of the markings 11, 21 may be the same or different. For example, the markings 11, 21 may both comprise a common brand name 30. The markings 11 on the first product 10 may comprise a first indicia 12. Similarly, the markings 21 on the second product 20 may comprise a second indicia 22. The first indicia 12 and the second indicia 22 may be the same or different and may comprise a 2-dimensional representation of a plant or an insect. The plant may be any type of plant. For example, the plant may be a weed or a flower. The insect may be any type of insect. For example, the insect may be a crawling insect or a flying insect. The first product 10 may comprise text 13, which may be parallel or substantially parallel with the resting plane 7. Similarly, the second product 20 may comprise text 23, which may be parallel or substantially parallel with the resting plane 7.

The first product 10 and the second product 20 may comprise pest control products that have the same or different intensive properties. For example, the first product may comprise a pest control product that targets flying insects such as flies and mosquitoes whereas the second product 20 may comprise a pest control product that targets ants and roaches or other ground dwelling insects. Similarly, the first product 10 may comprise an insecticide whereas the second product 20 may comprise an herbicide. The first product 10 may comprise an insecticide intended to repel pests whereas the second product 20 may comprise an insecticide intended to kill pests. This disclosure relates to arrays of such products that convey a clear or even an intuitive understanding of the intensive properties to a consumer so that the consumer can readily select the product they need.

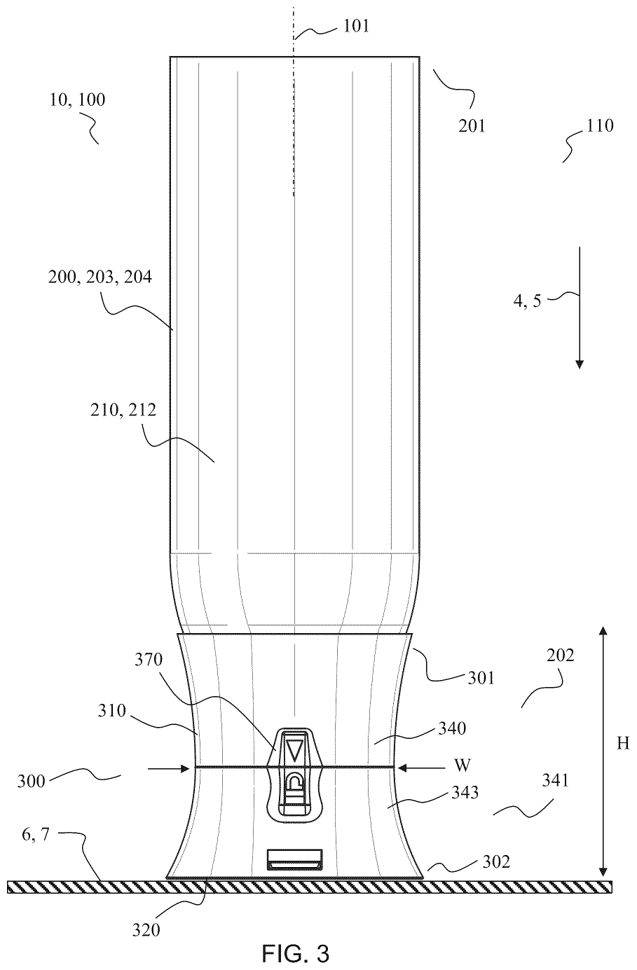

FIGS. 3-15 cooperate to illustrate various views of the first product 10, which may comprise an aerosol dispensing device 100 comprising a resting plane such that the first product may be shelved in an inverted orientation. Referring to FIG. 3, the aerosol dispensing device 100, may comprise an aerosol container 200 and an undercap 300. The aerosol container 200 may be aligned with and may cooperatively engage the undercap 300. The aerosol container may have a top portion 201 and a bottom portion 202. The undercap 300 may have a top portion 301 and a bottom portion 302 with a sidewall 310 extending therebetween. The undercap 300 may have a height H along the longitudinal axis 101 of from about 45 mm to about 80 mm, or from about 50 mm to about 70 mm, or from about 55 mm to about 65 mm. The undercap 300 may have a maximum width along the lateral axis from about 40 mm to about 90 mm, or from about 45 mm to about 90 mm, or from about 50 mm to about 70 mm. The sidewall 310 may be concave and the narrowest portion of the undercap 300 may be positioned at a junction of the top portion 301 and the bottom portion 302. The narrowest portion of the undercap 300 may have a minimum width W of from about 30 mm to about 70 mm, or from about 35 mm to about 65 mm, or from about 40 mm to about 50 mm. The dimensions of the undercap 300 may be selected to provide improved ergonomics for manually gripping and actuating the device. An aerosol dispensing device 100 comprising an undercap 300, as described herein, need not include (or may be free of) an additional protective cap or other additional protective element that affixes to the device (e.g., to the undercap) to inhibit accidental actuation of aerosol dispensing device. The absence of a protective cap may allow a user to more quickly actuate the aerosol dispensing device 100 and dispense the first product composition 210, without the additional step of removing the cap before actuating the device. This may be especially desirable when the first product composition 210 is a pesticidal product and the user is targeting a fast-moving pest.

The bottom portion 202 of the aerosol container 200 may be adjacent to and may cooperatively engage the top portion 301 of the undercap 300. A first product composition 210 and an aerosol propellant 212 may be disposed within a reservoir 204 of the aerosol container 200. The aerosol dispensing device 100 is in an inverted orientation 110, such that it is positioned to dispense an aerosol spray comprising the first product composition 210 in a generally downward direction 4 that substantially aligns with a direction of gravity 5. The aerosol container 200 comprises a wall 203. The wall 203 may comprise a plastic material, such as polyethylene terephthalate (PET), or a metal. PET may be preferred, as it is generally lighter than metal and may make the aerosol device 100 easier to use. The aerosol container 200, preferably at least a portion of the wall 203 of the container 200, may be transparent or translucent. The aerosol container 200 may further comprise a bag (not shown) within the wall 203 typically referred to a bag-in-bottle aerosol. The bag may also be comprised of a plastic material, such as polyethylene terephthalate (PET).

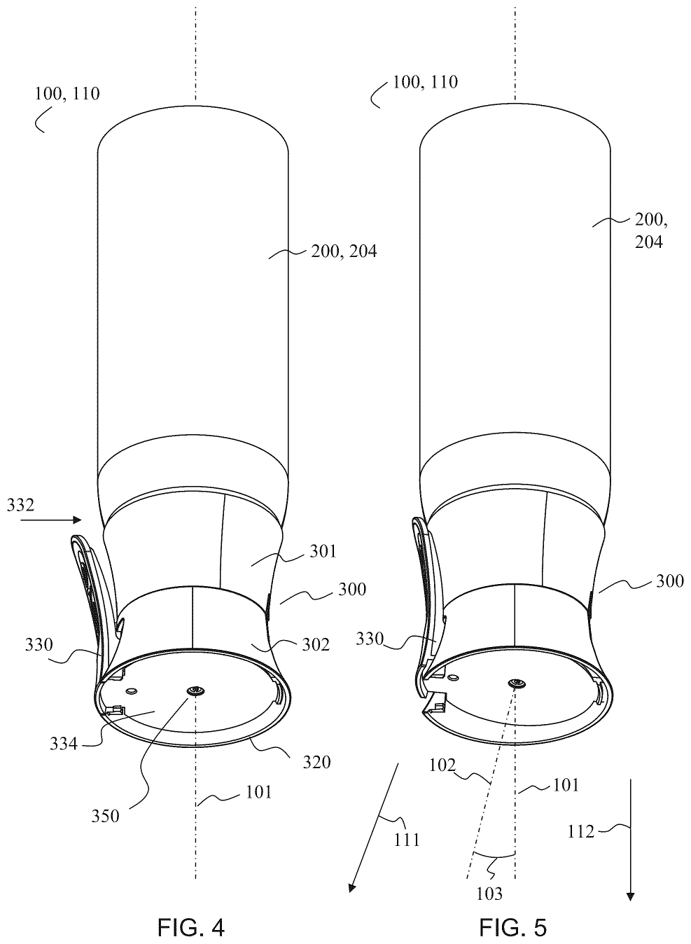

The aerosol dispensing device 100 may have a locked and an unlocked configuration, which may be selectively engaged by twisting either the top portion 301 or the bottom portion 302 of the undercap 300. As shown in FIG. 3, the aerosol dispensing device 100 is shown resting on a support surface 400 in a locked configuration. In the locked configuration, a rotatable portion 340, which may correspond with a top portion 301, of the undercap 300 is in a first rotational position 341 relative to a fixed portion 343, to allow spray to be dispensed from the aerosol dispensing device 100. Again, it is to be appreciated that, according to various embodiments, the top portion 301 may be the fixed portion 343 and the bottom portion 302 may be the rotatable portion 340. In an unlocked configuration, the rotatable portion 340 may be in a second rotational position (not shown) to allow spray to be dispensed from the aerosol dispensing device 100. Allowing or prohibiting spray may be accomplished, for example, by hindering movement of an actuator (e.g., actuator lever) 330, described hereinafter (See: FIGS. 4 and 5, for example). This locking feature may be particularly preferred in the absence of an overcap, in order to prevent unintentional actuation of the first product composition 210. An indicator 370 may provide a notification to a user as to whether the device 100 is in a locked or an unlocked configuration. As shown in FIG. 3, the aerosol dispensing device 100 is resting on a supporting surface 6, which may be a store shelf 2 or a packaging component of an array 3. The supporting surface 6 may define or may be parallel to or substantially parallel to a resting plane 7. More specifically, a base surface 320 of the undercap 300 is disposed on the supporting surface 6.

Referring to FIG. 4 and FIG. 5, the undercap 300 may comprise an actuator lever 330 pivotably coupled thereto, which may be depressed in a direction 332 toward a longitudinal axis 101 of the device 100. The undercap 300 may further comprise a through-hole 350 through which an aerosol spray may be dispensed. According to some non-limiting embodiments, the through-hole 350 may be disposed on a bottom surface 334 of the actuator lever 330.

FIG. 4 and FIG. 5 also cooperate to illustrate a dispensing angle 103 of the device 100 in an inverted orientation 110. FIG. 4 is a bottom perspective view of an aerosol dispensing device in a non-actuated state and FIG. 5 is a bottom perspective view of an aerosol dispensing device 100 in an actuated state, with the actuator lever 330 depressed. The device 100 may dispense an aerosol spray comprising the first product composition 210 in a generally downward direction 111 substantially along a spray axis 102 of the valve stem 223. The spray axis 102 of the valve stem 223 may be at an angle, the dispensing angle 103, relative to the longitudinal axis 101 of the device 100. The dispensing angle 103 may be about 0.25 degrees to about 5 degrees, or from about 0.5 degrees to about 4 degrees, or from about 0.75 degrees to about 3 degrees, or from about 1 degree to about 3 degrees. The dispensing angle 103 measure may be equal to, greater than, or less than the actuator pivot angle 226 measure. In some embodiments, the dispensing angle 103 measure may be less than the actuator pivot angle 226 measure.

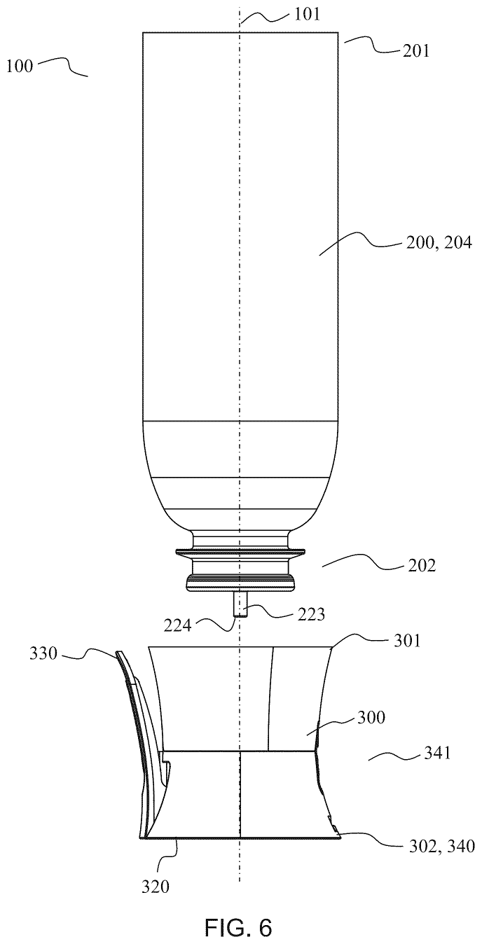

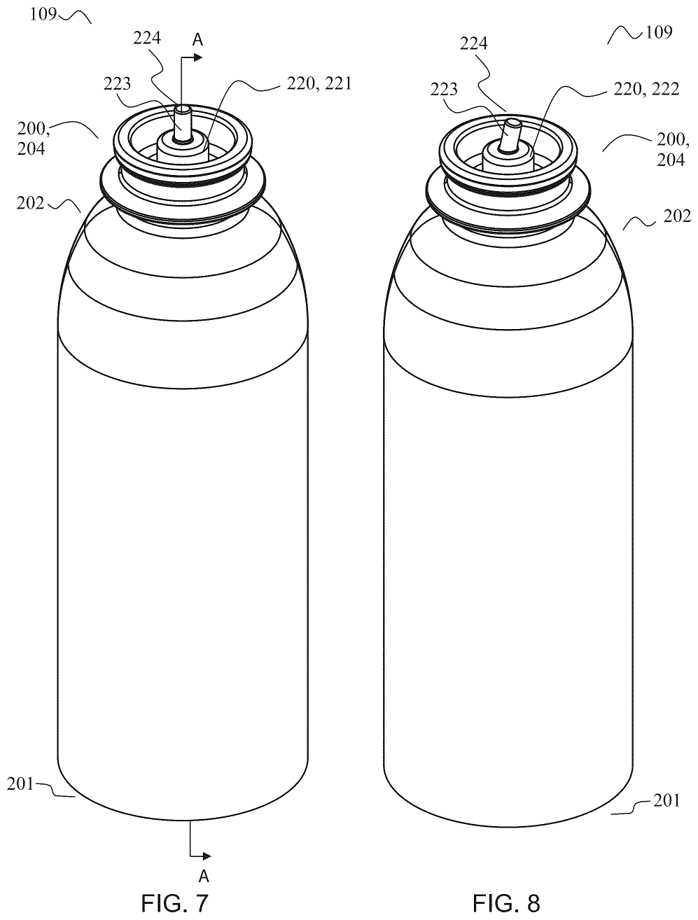

As shown in FIG. 4 (in an inverted orientation 110), when the actuator lever 330 is in a non-actuated state, the bottom surface 334 of the actuator lever 330 is substantially parallel to the base surface 320 of the bottom portion 302 of the undercap 300. And, as shown in FIG. 4 in combination with FIG. 7 (in an upright orientation 109), the actuator lever 330 does not displace the valve stem 223, the valve stem 223 does not displace the aerosol valve 220, the aerosol valve 220 is in the closed position 221, and the spray axis 102 of the valve stem 223 coincides with the longitudinal axis 101 of the device 100. In a non-actuated state, the exit orifice 224 of the valve stem 223 may be substantially parallel to the base surface 320 of the bottom portion 302 of the undercap 300 (see FIG. 6).

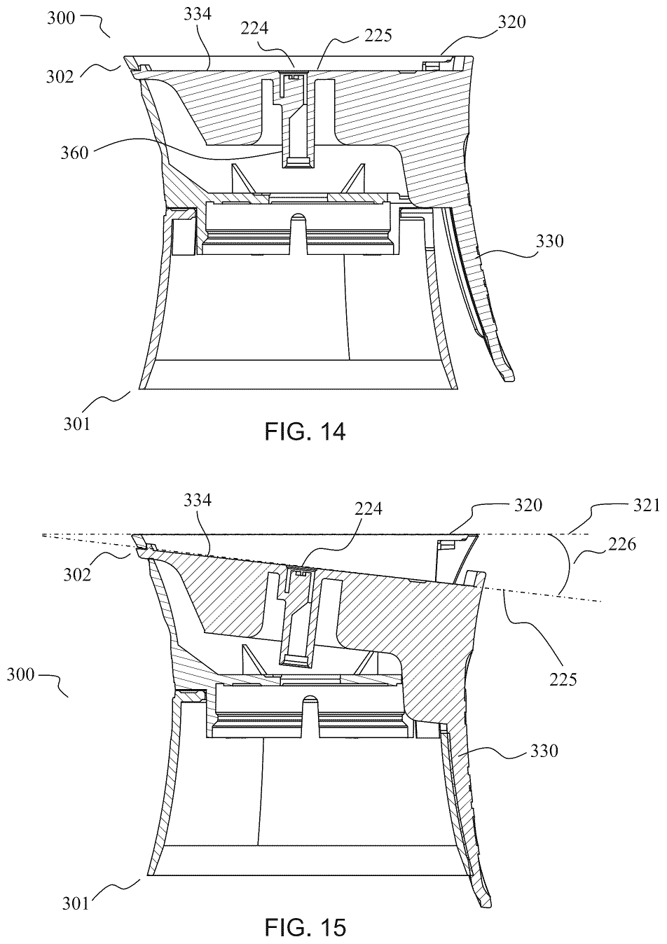

When the actuator lever 330 is depressed and in an actuated state, the bottom surface 334 of the actuator lever 330 may be at an actuator pivot angle 226 (See FIG. 15 for more details) of about 3 degrees to about 10 degrees out of plane with respect to the base surface 320 of the bottom portion 302 of the undercap 300. For convenience, the actuator pivot angle 226 is shown between a plane 321 aligned with the bottom surface 320 and a plane 225 aligned with the bottom surface 334 of the depressed actuator lever 330. And, as shown in FIG. 5 in combination with FIG. 8 (in an upright orientation 109), the actuator lever 330 displaces the valve stem 223, the valve stem 223 displaces the aerosol valve 220, the aerosol valve 220 is in the open position 222, and the spray axis 102 of the valve stem 223 is at an angle, the dispensing angle 103, relative to the longitudinal axis 101 of the device 100. The dispensing angle 103 may be about 0.25 degrees to about 5 degrees, or from about 0.5 degrees to about 4 degrees, or from about 0.75 degrees to about 3 degrees, or from about 1 degree to about 3 degrees. The dispensing angle 103 measure may be equal to, greater than, or less than the actuator pivot angle 226 measure. In some embodiments, the dispensing angle 103 measure may be less than the actuator pivot angle 226 measure. FIG. 6 provides a partially exploded view of an aerosol dispensing device 100, showing an aerosol container 200 and an undercap 300. As shown, in FIG. 6, the aerosol container 200 may comprise a valve stem 223, which may be aligned with the longitudinal axis 101 of the device 100 and which may be disposed within the undercap 300 to cooperatively engage a stem engaging channel 360 thereof (See: FIG. 14). The aerosol container 200 may also comprise an exit orifice 224. The exit orifice 224 of the valve stem 220 may be substantially parallel to the base surface 320 of the bottom portion 302 of the undercap 300 when the device 100 is not dispensing any aerosol spray, which may correspond to a non-actuated state of the actuator (e.g., actuator lever) 330.

FIG. 7 is a front perspective view of an aerosol container 200 with an aerosol stem 223 displacing an aerosol valve 220 to a closed position 221. FIG. 8 is a front perspective view of an aerosol container 200 with an aerosol stem 223 displacing an aerosol valve 220 to an open position 222. In both figures, the aerosol container 200 is shown in an upright orientation. The aerosol container 200 may have a top portion 201 and a bottom portion 202. At or adjacent to the bottom portion 202, the aerosol container 200 may comprise an aerosol valve 220 and a valve stem 223. The valve stem 223 may displace the aerosol valve 220 between a closed position 221 and an open position 222. When the valve stem 223 displaces the aerosol valve 220 to the open position 222, the spray axis 102 of the valve stem 223 may be at an angle, the dispensing angle 103, relative to a longitudinal axis 101 of the device and the dispensing angle 103 may be about 0.5 degrees to about 5 degrees, or from about 0.5 degrees to about 4 degrees, or from about 0.5 degrees to about 3 degrees, or from about 1 degree to about 3 degrees. When the valve stem 223 displaces the aerosol valve 220 to the open position 222, the valve stem 223 is preferably biased towards the actuator lever 330.

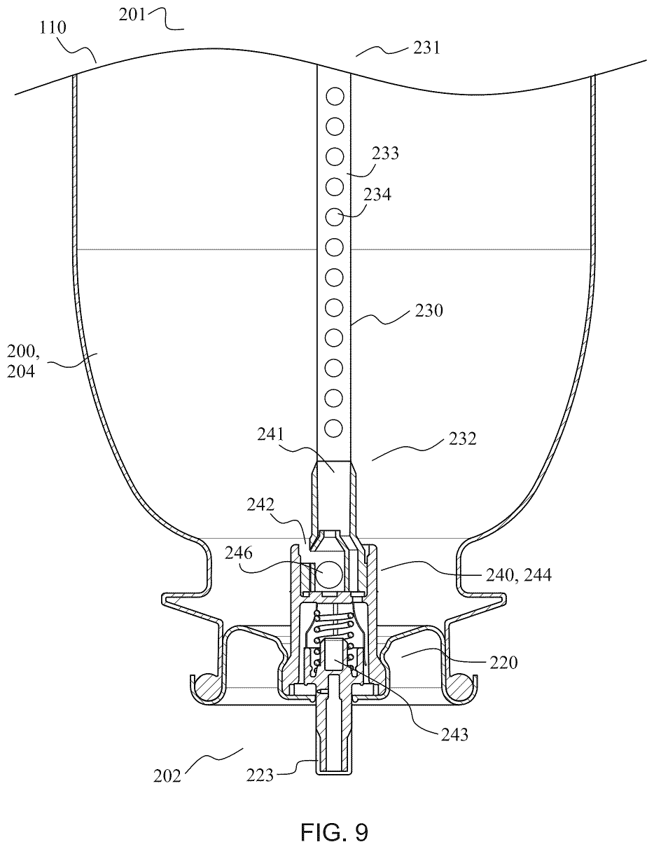

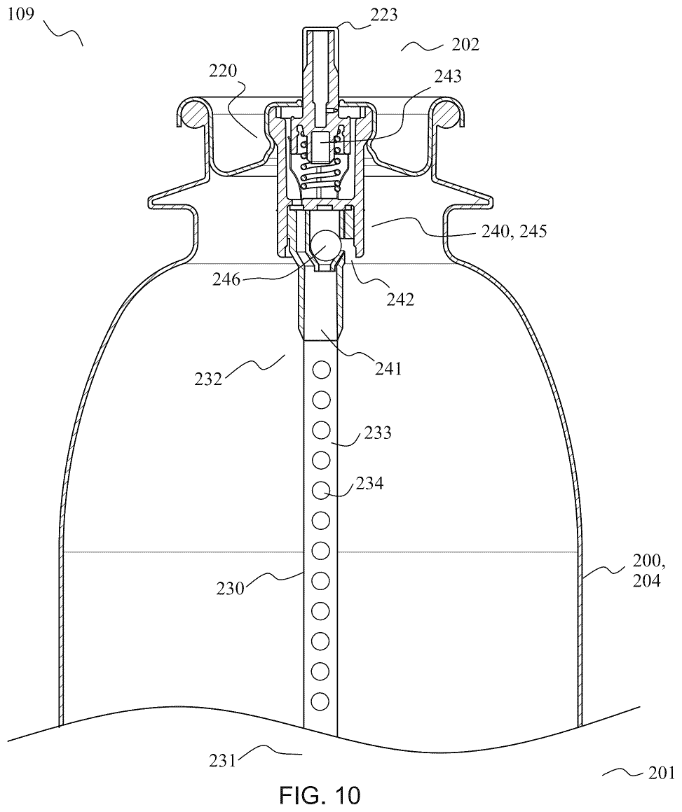

FIG. 9 is a front, cross-sectional view along line A-A in FIG. 7 of an aerosol container comprising a check valve 240 and a dip tube 230, in an inverted orientation 110. FIG. 10 is a front, cross-sectional view along line A-A in FIG. 7 of an aerosol container comprising a check valve 240 and a dip tube 230, in an upright orientation 109. The dip tube 230 may comprise a first end 231 extending to and in fluid communication with the top portion 201 of the aerosol container 200. The dip tube 230 may also comprise a second end 232 extending to the bottom portion 202 of the aerosol container 200. According to various embodiments, the dip tube 230 may comprise a continuous wall 233 devoid of openings, such as pores or perforations, other than at the first end 231 and the second end 232. According to other embodiments, the dip tube 230 may comprise a wall 233 with pores, such as a membrane, where the membrane is substantially impermeable to gas but allows liquid (e.g., liquid composition) to pass through. For example, the dip tube 230 may be a hollow tubular membrane, such as the “Anyway Spray Tube” available from Pritchard Spray Technology Ltd and generally disclosed in U.S. Pat. No. 9,637,396. Generally, a dip tube 230 having a continuous wall 233 without pores is employed in association with a check valve 240 and a dip tube 230 having a wall 233 with pores is employed without a check valve 240, but any combination of these features may be employed. The check valve 240 may comprise first inlet 241 in fluid communication with the second end 232 of the dip tube 230. The check valve 240 may also comprise second inlet 242 in fluid communication with aerosol container 200. The aerosol container 200 may comprise a wall 203 that defines an interior reservoir. The check valve 240 may also comprise an outlet 243 in fluid communication with the aerosol valve 220. Finally, the check valve 240 may comprise a ball 246. When the device 100, and thereby the aerosol container 200, is in an inverted orientation 110, the ball 246 may be in a first position 244 blocking flow through the first inlet 241 and allowing flow through the second inlet 242. When the device 100, and thereby the aerosol container 200, is in an upright orientation 109, the ball 246 may be in a second position 245 blocking flow through the second inlet 242 and allowing flow through the first inlet 241. As discussed above, additionally or alternatively, the dip tube 230 may comprise one or more perforations 234.

In some embodiments, the aerosol container may comprise a bag-on-valve system and may be devoid of a check valve 240 and/or a dip tube 230 (not shown). Bag-on-valve systems are known in the art.

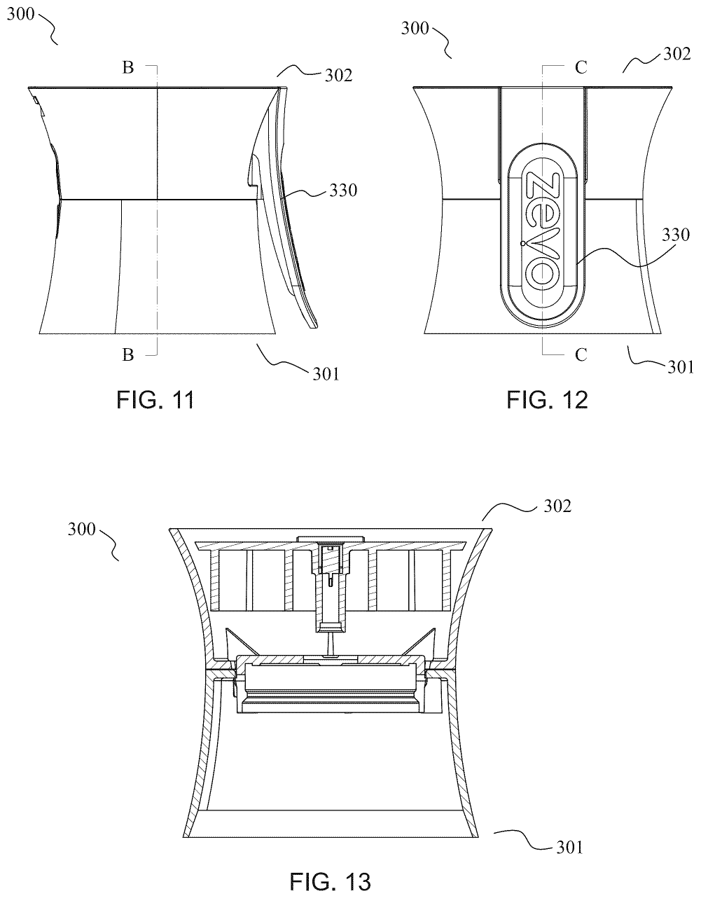

FIG. 11-FIG. 15 cooperate to illustrate various views of an undercap 300. FIG. 11 provides a side view, and FIG. 12 provides a back view of an undercap 300. The undercap 300 may comprise an actuator lever 330 that may include a stem-engaging channel 360 that may be aligned with the longitudinal axis 101 and may be configured to engage the valve stem 223 of an aerosol container 200 when the device 100 is fully assembled. Actuation of the actuator lever 330 displaces the valve stem 223, as shown in FIG. 8, to cause the valve stem 223 to displace the aerosol valve 220 between a closed position 221 and an open position 222. FIG. 13 is a cross-sectional view along line B-B in FIG. 11 view of an undercap 300.

FIG. 14 is a cross-sectional view along line C-C in FIG. 12 of an undercap 300 with the actuator lever 330 in a non-actuated state. FIG. 15 is a cross-sectional view along line C-C in FIG. 12 of an undercap 300 with the actuator lever 330 depressed. According to various embodiments, when the actuator lever 330 is in a non-actuated state, as shown in FIG. 14, the bottom surface 334 of the actuator lever 330 (including the through-hole 350) may be substantially parallel to the base surface 320 of the bottom portion 302 of the undercap 300. According to various embodiments, when the actuator lever 330 is depressed, as shown in FIG. 15, the bottom surface 334 of the actuator lever 330 may be at an actuator pivot angle 226 of 3 degrees to about 10 degrees, or from about 4 degrees to about 9 degrees, or from about 5 degrees to about 8 degrees, or from about 5.5 degrees to about 7.5 degrees, out of plane with respect to the base surface 320 of the bottom portion 302 of the undercap 300. For convenience, the actuator pivot angle 226 is shown between a plane 321 aligned with the bottom surface 320 and a plane 225 aligned with the bottom surface 334 of the depressed actuator lever 330.

With general reference to FIGS. 1-15, various embodiments relate to an inverted aerosol dispensing device 100, comprising an aerosol container 200 extending between a top portion 201 and a bottom portion 202 for containing a first product composition 210 and an aerosol propellant 212 therein. The device 100 may also comprise an aerosol valve 220 located at the bottom portion 202 of the aerosol container 200. The aerosol valve 220 may have a valve stem 223 for displacing the aerosol valve 220 from a biased closed position 221 to an open position 222 upon a movement of the valve stem 223 to discharge the first product composition 210 from the valve stem 223. The device 100 may also comprise an undercap 300 having a sidewall 310 extending between a top portion 301 and a bottom portion 302. The undercap 300 may be mounted to the aerosol container 200 with the top portion 301 of the undercap 300 being adjacent to the bottom portion 202 of the aerosol container 200. The bottom portion 302 of the undercap 300 may terminate in a base surface 320 for supporting the aerosol dispensing device 100 on a supporting surface 400 to store the aerosol dispensing device 100 in an inverted position 110. The device 100 may also comprise an actuator lever 330 located adjacent and outboard of the sidewall 310 of said undercap 300, being movably mounted relative to the undercap 300 and configured to move the valve stem 223 when the actuator lever 330 is moved. According to various embodiments, when the valve stem 223 displaces the aerosol valve 220 to the closed position 221 the exit orifice 224 of the valve stem 220 is substantially parallel to the base surface 320 of the bottom portion 302 of the undercap 300 (see FIG. 6), and when the valve stem 223 displaces the aerosol valve 220 to the open position 222, the spray axis 102 of the valve stem 223 may be at an angle, the dispensing angle 103, relative to a longitudinal axis 101 of the device. The dispensing angle 103 may be about 0.25 degrees to about 5 degrees, or from about 0.5 degrees to about 4 degrees, or from about 0.75 degrees to about 3 degrees, or from about 1 degree to about 3 degrees. The valve stem 223 may preferably be biased towards the actuator lever 330, when the valve stem 223 displaces the aerosol valve 220 to the open position 222.

Various embodiments relate to an inverted aerosol dispensing device 100, comprising an aerosol container 200 extending between a top portion 201 and a bottom portion 202 for containing a first product composition 210 and an aerosol propellant 212 therein. The device 100 may also comprise an aerosol valve 220 located at the bottom portion 202 of the aerosol container 200, a check valve 240 located adjacent the aerosol valve 220, and a dip tube 230 with a first end 231 extending to and in fluid communication with the top portion of the aerosol container and a second end 232 extending to the bottom portion 202 of the aerosol container 200. The check valve 240 may have a first inlet 241 in fluid communication with the second end 232 of the dip tube 230, a second inlet 242 in fluid communication with aerosol container 200, and an outlet 243 in fluid communication with the aerosol valve 220. The aerosol valve 220 may have a valve stem 223 for displacing the aerosol valve 220 from a biased closed position 221 to an open position 222 upon a movement of the valve stem 223 to discharge the first product composition 210 from the valve stem 223. The check valve 240 may have a first position 244 when the aerosol container 200 is spatially oriented such that the top portion 201 of the aerosol container 200 is above the bottom portion 202 of the aerosol container 200 and a second position 245 when the aerosol container 200 is spatially oriented such that the top portion 201 of the aerosol container 200 is below the bottom portion 202 of the aerosol container 200. According to various embodiments, when the check valve 240 is in the first position 244 the check valve 240 closes the first inlet 241 preventing liquid communication between the first inlet 241 and the dip tube 230 and when the check valve 240 is in the second position 245 the check valve 240 closes the second inlet 242 preventing liquid communication between the second inlet 242 and the aerosol container 200. The device 100 may also comprise an undercap 300 having a sidewall 310 extending between a top portion 301 and a bottom portion 302. The undercap 300 may be mounted to the aerosol container 100 with the top portion 301 of the undercap 300 being adjacent to the bottom portion 202 of the aerosol container 200. The bottom portion 302 of the undercap 300 may terminate in a base surface 320 for supporting the aerosol dispensing device 100 on a supporting surface 400 to store the aerosol dispensing device 100 in an inverted position 110. The device 100 may also comprise an actuator lever 330 located adjacent and outboard of the sidewall 310 of said undercap 300, being movably mounted relative to the undercap 300 and configured to move the valve stem 223 when the actuator lever 330 is moved. According to various embodiments, a rotatable portion 340 of the undercap 300 may be rotatable into a first rotational position 341 relative to the aerosol container 200 for enabling the actuator to move the valve stem 223 upon movement of the actuator lever 330 for discharging the first product composition 210 from the valve stem 223 in a generally downwardly direction 111. The undercap 300 may be rotatable into a second rotational position 342 relative to the aerosol container 200 for inhibiting the actuator from moving the valve stem 223.

The device 100, according to various embodiments, allows the first product composition 210 to be dispensed when the device 100 is in an upright orientation 109 or in an inverted orientation 110. The device 100 may provide better ergonomics, imparting little strain to a consumer's hand or wrist when dispensing. The actuator lever 330 may be paddle-shaped and may allow a consumer to use a finger or a thumb to actuate. The actuator pivots on a hinge such that the dispensing surface is at about a 6 degree angle (actuator pivot angle 226) relative to the resting plane and biased towards the paddle. This small angle can help a consumer aim the product. It's small enough to not be noticed by consumer but over a throw distance of about 0.3 m to about 1.5 m, preferably about 0.3 m to about 1 m, can help the consumer aim. More specifically, the device 100, according to various embodiments, can help to direct the first product composition 210 to a desired location, because the valve stem 223 and the exit orifice 224 of the valve stem tilt slightly towards the actuator lever 330, when the device 100 is actuated, thereby creating a substantially unnoticeable but useful bias to better spray a target surface. The device 100 may produce a spray that travels an appropriate distance (about 0.3 m to about 1.5 m, preferably about 0.3 m to about 1 m) so that a consumer can apply the first product composition 210 to surfaces without bending down or reaching high.

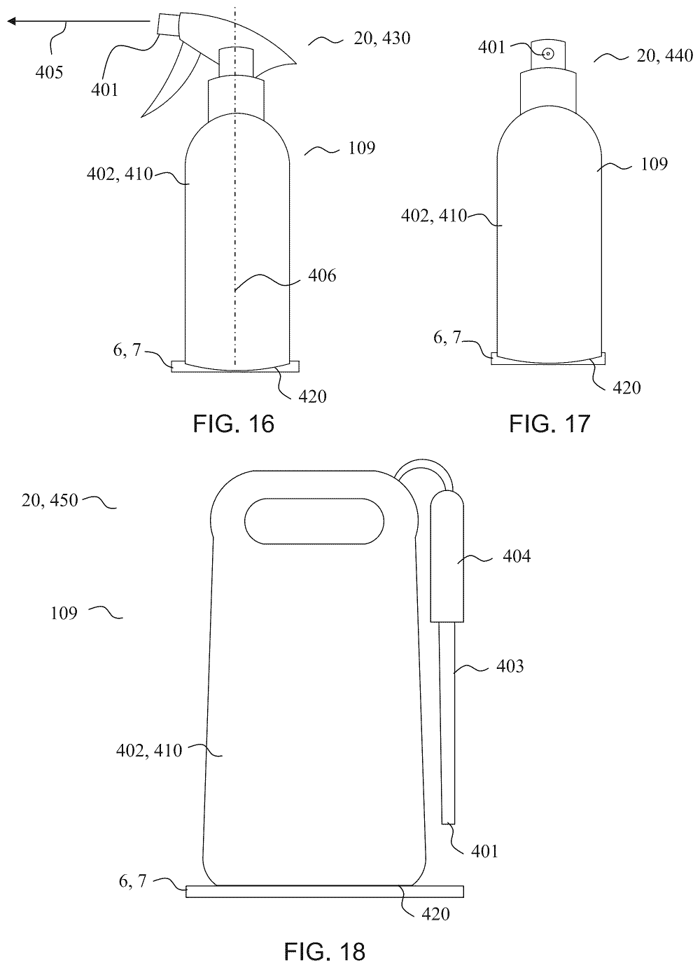

FIGS. 16-18 cooperate to illustrate some examples of the second product 20. FIG. 16 is a schematic illustration of a first type 430 of the second product 20 shelved in an upright orientation 109. The first type 430 may be a trigger-style spray bottle. FIG. 17 is a schematic illustration of a second type 440 of the second product 20 shelved in an upright orientation 109. The second type 440 may be a top-down, spritz-style spray bottle. FIG. 18 is a schematic illustration of a third 450 type of the second product 20 shelved in an upright orientation 109. The third type 450 may be a yard spraying product comprising a wand 403 and battery powered pump 404. It is to be appreciated that these examples are not limiting and that a variety of other types of products that may be stored with in an upright orientation may also be employed as the second product 20. In all cases, the second product 20 may comprise a nozzle 401 and a reservoir 402. The reservoir 402 may comprise a second product composition 410. The reservoir 402 may comprise a base 420 that may rest on a support surface 6 having a resting plane 7 in an upright orientation 109. According to various embodiments, the second product 20 may also have a discharge direction 405 that is substantially perpendicular to a longitudinal axis 406 of the second product's reservoir 402.

### Product Compositions

The first product 10 may comprise a first product composition 210 and the second product 20 may comprise a second product composition 410. The first product composition 210 and the second product composition 410 may be the same composition or different compositions. Each composition 210, 410 may be selected from any of the various product compositions described herein, as well as from any possible combinations thereof.

One useful type of product composition may be an aerosol pesticidal product. An aerosol product may comprise a composition, preferably a liquid composition, which may be housed within the aerosol container 200. The container may store from about 50 g to about 600 g, or from about 150 g to about 400 g, or from about 200 g to about 350 g, of the composition. The weight of the aerosol product, including the composition, is preferably selected to enable a user to comfortably manipulate and actuate the product with one hand, while providing enough composition to treat one or multiple target areas/surfaces of varying sizes, once or multiple times, e.g., multi-use product (e.g., a multi-use product). The aerosol product may be a consumer use product intended to be sprayed onto a target surface. Non-limiting examples aerosol pesticidal products include herbicides, insecticides, insect barrier products, and garden insecticides. The aerosol products may also be suitable for commercial and/or institutional use.

The composition may have a Brookfield viscosity from about 1 cps to about 500 cps, or from about 1 cps to about 300 cps, or from about 2 cps to about 100 cps, or from about 3 cps to about 50 cps. The Brookfield viscosity may enable the aerosol dispensing device to dispense the composition as droplets. For some products, such as pesticide products, droplets may be preferred, particularly versus a mist, a stream, or a foam. The composition may have a surface tension from about 10 mN/m to about 60 mN/m, or from about 15 mN/m to about 50 mN/m, or from about 18 mN/m to about 40 mN/m, or from about 20 mN/m to about 30 mN/m, or from about 22 mN/m to about 28 mN/m, as measured according to the method described herein. It is believed that droplets may be preferred for delivering a targeted spray (particularly for non-selective herbicide compositions), while also sufficiently covering a target area.

The composition may comprise particles having an intensity mean particle size of from about 2 nm to about 500 nm, alternatively from about 3 nm to about 400 nm, alternatively from about 4 nm to about 100 nm. The composition may comprise particles having an intensity mean particle size of less than about 1 micron, preferably less than about 500 nm. Mean intensity particle size can be measured according to the Particle Size Test Method described hereafter.

The composition may comprise particles having a volume mean particle size ranging from about 1 nm to about 100 nm, or from about 2 nm to about 50 nm, or from about 2 nm to about 25 nm, or from about 2 nm to about 10 nm. The composition may comprise particles having a volume mean particle size of less than about 1 micron, preferably less than about 500 nm. Mean volume particle size can be measured according to the Particle Size Test Method described hereafter. Volume mean particle size may be selected to provide a transparent or translucent composition, as well as to efficiently deliver an active agent to the target surface or area.

As detailed below, in the Spray Droplet Size Test Method, spray droplet volume size distribution measurements comprising Spray D(50) Normalized, Spray D(90) Normalized, and Spray D(2,3) Normalized values are determined using a Malvern Spraytec 2000 laser diffraction spray droplet sizing instrument (supplied by Malvern Instruments, Worcestershire, UK). The composition, when dispensed through the aerosol dispensing device 100, may have a Spray D(90) ranging from about 100 microns to 900 microns, or from about 125 microns to about 800 microns, or from about 150 microns to about 700 microns. Spray D(90) may be selected to efficiently deliver an active agent to the target surface or area. Also, a Spray D(90) in the disclosed ranges may be perceived as capable of traveling a distance of one or more meters and depositing on a target surface. Particles having a Spray D(90) less than 100 microns may create a spray that is too misty or a spray that does not have sufficient velocity to travel to a target surface.

The composition may have a NTU value less than about 200, or less than about 100 or from about 0.5 to about 50, or from about 1 to about 25. A composition having a NTU value in the disclosed ranges may be perceived by a consumer as being clear, transparent, or translucent, which may connote purity, quality, and/or that the composition is not likely to stain surfaces.

The composition may have a b* value from about 0 to about 5, or from about 0.01 to about 4, or from about 0.05 to about 3.5, or from about 0.1 to about 3. A composition with a b* value according to the disclosed ranges may be perceived by a consumer as having a colorless appearance, while b* values outside the disclosed ranges, especially b* values greater than 5, may appear yellow to a consumer, which may connote that the composition contains impurities, has degraded, and/or is unsuitable for use.

As noted above, at least a portion of the wall 203 of the aerosol container 200 or the entire wall 203 may be transparent or translucent. A transparent or translucent wall 203 or a transparent or translucent portion thereof (e.g., a window) may allow a user to view the composition inside the container 200, without having to dispense the composition. This may be particularly desirable for compositions having NTU values less than about 200 and/or having b* values from about 0 to about 5.

The aerosol dispensing device may have a spray rate ranging from about 0.5 g/s to about 5 g/s, or from about 0.75 g/s to about 4 g/s, or from about 1.25 g/s to about 3.5 g/s, or from about 1.5 g/s to about 3 g/s. The spray rate may be selected to enable targeted dispensing and delivery of the composition from the aerosol dispensing device, without over-spraying or spraying composition outside the target area.

The aerosol container 200 may comprise a propellant 212. Examples of suitable propellants include compressed gasses, such as nitrogen, carbon dioxide, and air; liquidized hydrocarbons, such as butane, isobutate, and propane; hydrofluoro-olefins, and mixtures thereof. The propellant may be selected from the group consisting of nitrogen, carbon dioxide, and mixtures thereof. The aerosol container 200 may have an internal gage pressure of from about 414 kPa to about 1,100 kPa, or from about 600 kPa to about 1,000 kPa, or from about 700 kPa to about 900 kPa. Preferably, the aerosol product is a pest control product comprising a pest control composition. As used herein, “pest control” means the management of a pest species, including any animal, such as insects and other arthropods, plant, or fungus that adversely impacts human activities or the environment, where management includes controlling, killing, eliminating, repelling, or attracting the pest species. The terms “pest control” and “pesticide” are used interchangeably, and it is understood that a composition or an ingredient that has “cidal” activity, e.g., pesticide, insecticide, herbicide, fungicide, may or may not kill and/or eliminate the target pest, e.g., arthropod, insect, weed, or fungus. As used herein, “cide” and “cidal” includes compositions, compounds, components, ingredients, materials, etc., which are effective to kill, remove, destroy, defoliate, exterminate, eradicate, eliminate, etc., a target pest, as well as to retard, regulate, inhibit, prevent, etc., the survival, growth, and/or proliferation of such pest.

Pest control products and compositions may include products and compositions for managing a pest species inside and outside of a building, such as a dwelling or a business, including, but not limited to, areas such as garages, patios, balconies, screened porches, lawns, and/or gardens. Pest control products and compositions may include products and compositions for use in and/or on yards, lawns, bushes, trees, and/or outdoor plants, as well as for use on or around indoor plants. Pest control products and compositions may include selective and non-selective products and compositions, such as selective and non-selective herbicides, fungicides, and insecticides. Pest control products and compositions may also include products and compositions for topical application to humans to control or repel pest species, such as insects and other arthropods.

In particular, the market for weed control products and arthropod pest control products is growing, due to factors such as an increase in urban housing, changes in weather patterns, and an increase in home food gardening and the desire to keep lawns, flower beds, etc. looking neat and attractive. At the same time, there is increasing consumer demand for insecticide and herbicide products that are natural and non-toxic. Consumers also prefer herbicide and insecticide products that contain a limited number of ingredients and/or recognizable ingredients, as communicated by simpler ingredient statements. However, these products are still expected to be efficacious and efficiently control weeds and arthropods, comparable to traditional chemical pesticide products. Also, there are existing herbicide and insecticide products that contain natural ingredients, such as plant essential oils. However, these existing products have a number of disadvantages: some products are messy or difficult to use and some products have limited efficacy.

The pest control composition may be oil-based and comprises at least one carrier oil. The carrier oil may be a hydrocarbon oil, such as a hydrocarbon oil derived from petroleum, animal, or plant sources. An example of a suitable petroleum-derived oil is mineral oil. An example of a suitable animal-derived oil includes fish oil. Examples of suitable plant-derived oils include corn oil, soybean oil, palm oil, rapeseed oil, sesame oil, wheat oil, wheat germ oil, coconut oil, canola oil, sunflower oil, safflower oil, peanut oil, olive oil, and castor oil. The hydrocarbon oil may be paraffinic, naphthenic and/or aromatic. The pest control composition may comprise a single carrier oil or a mixture of carrier oils. The pest control composition may comprise greater than about 25 percent by weight of a carrier oil, or from about 30% by weight to about 99.5% by weight of a carrier oil, or from about 50% by weight to about 98% by weight of a carrier oil, or from about 80% by weight to about 95% by weight of a carrier oil or from about 85% by weight to about 95% by weight of a carrier oil. Pest control compositions comprising carrier oils are described in US Pat. Pub. No. 2021/0169061A1, which is hereby incorporated by reference herein.

Alternatively, the pest control compositions may be substantially free of a geologically derived (e.g., petroleum-based) carrier oils, such as mineral oil, as products containing a carrier oil may be messy to use and may leave a residue on a treated surface.

The pest control compositions may comprise from about 40% to about 99%, or from about 45% to about 98%, by weight of the composition of water. The pest control composition may comprise from about 40% to about 96% water, or from about 60% to about 95%, or from about 50% to about to about 92%, or from about 70% to about to about 90%, or from about 55% to about 85%, or from about 78% to about 83%, or from about 58% to about 78%, or from about 60% to about 75%, or from about 62% to about 72%, all by weight of the composition. Such pest control compositions comprising water are described in U.S. application Ser. No. 17/865,943, U.S. application Ser. No. 18/082,891, U.S. application Ser. No. 18/334,004, and U.S. Provisional App. Ser. Nos. 63/509,339 and 63/509,380, all of which are hereby incorporated by reference herein.

The pest control composition may be an herbicide compositions and comprise from about 40% to about 99% by weight of the composition of water and are described in WO App. Ser. No. PCT/US23/68554 and U.S. Provisional App. Ser. No. 63/355,134, which are hereby incorporated by reference herein.

The pest control compositions of the present disclosure may comprise renewable components. The compositions disclosed herein may comprise from about 1%, or from about 5%, or from about 10%, or from about 20%, or from about 30%, of from about 40%, or from about 50%, to about 40%, or to about 50%, or to about 60%, or to about 70%, or to about 80%, or to about 90%, or to about 100% by weight of renewable components. The compositions disclosed herein may be at least partially or fully bio-based, As such, the composition can comprise a bio-based carbon content of about 50% to about 100%, preferably about 70% to about 100%, more preferably about 75% to about 100%, even more preferably about 80% to about 100%, most preferably about 90% to about 100%. The percent bio-based carbon content can be calculated as the “percent Modern Carbon (pMC)” as derived using the methodology of ASTM D6866-16. The compositions of the present disclosure may be substantially free of petroleum-derived solvents or petroleum-derived surfactants.

The compositions disclosed herein may comprise less than about 15 ingredients, preferably less than about 10 ingredients, more preferably less than about 15 ingredients and greater than about 5 ingredients.

The compositions disclosed herein may comprise ingredients listed under section 25(b) of the Federal Insecticide, Fungicide, and Rodenticide Act (FIFRA), incorporated herein by reference in its entirety. The compositions disclosed herein may comprise naturally occurring compounds or extracts or derivatives thereof. The compositions disclosed herein may comprise at least one organic, certified organic, US Department of Agriculture (“USDA”) National Organic Program compliant (“NOP-compliant”) ingredient. The compositions disclosed herein may comprise at least one ingredient that is food grade or generally recognized as safe (GRAS). The GRAS ingredient may include any agent listed on the FDA's GRAS list, including direct food additives (see, e.g., US law (sections 201(s) and 409 of the Federal Food, Drug, and Cosmetic Act, November 2016). The GRAS ingredient may also include, but is not limited to, agents that are generally recognized, among experts qualified by scientific training and experience to evaluate their safety, as having been adequately shown through scientific procedures (or, in the case of a substance used in food prior to Jan. 1, 1958, through either scientific procedures or through experience based on common use in food) to be safe. The use of food grade or GRAS ingredients enables the compositions disclosed herein to be used by consumers without rinsing a treated surface after use. The compositions disclosed herein may comprise ingredients that have a tolerance or tolerance exemption for use on food contact surfaces under the Federal Food, Drug, and Cosmetic Act US law (see, e.g., 40 CFR 180, November 2016, December 2015 update).

### Active Ingredients

The pest control composition may comprise one or more active ingredients (also referred to herein as actives). The pest control composition may comprise from about 0.005% to about 30%, or from about 0.05% to about 25%, or from about 0.15% to about 20%, or from about 0.5% to about 15%, or from about 1% to about 12%, or from about 2% to about 10% by weight of the composition of one or more active ingredients.

Nonlimiting examples of active ingredients include aldehyde C16 (pure), almond oil, terpenes, alpha-terpineol, verbenone, alpha-cedrene, cinnamic aldehyde, amyl cinnamic aldehyde, cinnamyl acetate, amyl salicylate, anisic aldehyde, citric acid, cedrol, benzyl alcohol, benzyl acetate, cinnamaldehyde, cinnamic alcohol, carvacrol, caryophyllene, carveol, citral, citronellal, methylheptenone, citronellol, dimethyl salicylate, eucalyptol (also known as 1,8-cineole), thujopsene, 3-thujopsanone, alpha-thujone, beta-thujone, fenchone, eugenyl acetate (e.g., isoeugenyl acetate), eugenol, iso-eugenol, methyl iso-eugenol, galaxolide, geraniol, guaiadiene, guaiacol, ionone, menthol (e.g., L-menthol), menthyl ester, menthone, carvone (e.g., L-carvone), camphor, camphene, p-cymene, borneol, bornyl esters, bornyl acetate, isobornyl acetate, terpinene (e.g., gamma-terpinene), methyl anthranilate, methyl ionone, methyl salicylate, nerol, phellandrene (e.g., alpha-phellandrene), pennyroyal oil, perillaldehyde, 1- or 2-phenyl ethyl alcohol, 1- or 2-phenyl ethyl propionate, piperonal, piperonyl acetate, piperonyl alcohol, D-pulegone, terpinen-4-ol, terpinyl acetate, 4-tert butylcyclohexyl acetate, myrcene, chavicol, acetaldehyde, safrole, terpinen-4-ol, cineole, dimethyl trisulfide, diallyl disulfide, diallyl sulfide, diallyl tetrasulfide, 3-vinyl-[4H]-1,2-dithiin, thyme oil, thyme oil white, thyme oil red, thymol, anethole (e.g., trans-anethole), vanillin, ethyl vanillin, castor oil, cedar oil, cedarwood oil, cinnamon, cinnamon oil, citronella, citronella oil, clove, clove oil, corn oil, corn mint oil, oregano oil, cottonseed oil, garlic, garlic oil, geranium oil, lemongrass oil, linseed oil, mint, mint oil, peppermint, peppermint oil, spearmint, rose oil, spearmint oil, rosemary, rosemary oil, sesame, sesame oil, soybean oil, white pepper, licorice oil, wintergreen oil, anise oil (e.g., star anise oil), lilac flower oil, black seed oil, bay oil, grapefruit seed oil, grapefruit, lemon oil, orange oil, orange flower oil, tea tree oil, cedar leaf oil, camphor oil, Tagete minuta oil, lavender oil, Lippia javancia oil, oil of bergamot, galbanum oil, eucalyptus oil, lovage oil, and mixtures thereof.

The pest control composition may comprise about 0.005% to about 15%, preferably from about 0.05% to about 15%, more preferably from about 0.15% to about 12%, even more preferably from about 0.5% to about 10% of one or more active ingredients selected from the group consisting of eugenol, 2-phenylethyl propionate, menthol, menthone, amyl butyrate, geraniol, limonene (e.g., d-limonene), p-cymene, linalool, linalyl acetate, camphor, methyl salicylate, pinene (e.g., alpha-pinene, beta-pinene), eucalyptol, piperonal, piperonyl alcohol, tetrahydrolinalool, thymol, carvone (e.g., L-carvone), vanillin, ethyl vanillin, iso-eugenol, bornyl acetate, isobornyl acetate, terpinene (e.g., gamma-terpinene), cinnamyl acetate, cinnamic alcohol, cinnamaldehyde, ethyl cinnamate, pyrethrins, abamectin, azadirachtin, amitraz, rotenone, boric acid, spinosad, biopesticides, synthetic pesticides, and mixtures thereof.

The pest control composition may comprise one or more synthetic pesticides. Nonlimiting examples of synthetic pesticides include pyrethroids, such as bifenthrin, esfenvalerate, fenpropathrin, permethrin, cypermethrin, cyfluthrin, deltamethrin, allethrin, lambda-cyhalothrin, or the like; syngergists, such as piperonyl butoxide, or the like; juvenile hormone analogues, such as methoprene, hydroprene, kinoprene, or the like; and neonicotinoids, such as imidacloprid, acetamiprid, thiamethoxam, or the like, and mixtures thereof. Additional examples of synthetic pesticides include glyphosate, dicamba, diquat dibromide, fluazifop, paraquat, pelargonic acid, nonanoic acid, triclopyr, imazapyr, and 2,4-D: 2,4-dichlorophenoxyacetic acid (2,4-D). The pest control composition may comprise less than about 25%, such as from about 0.00005% to about 10%, or less than about 5%, such as from about 0.0001% to about 5%, or less than about 2%, such as from about 0.001% to about 2%, or less than about 1%, such as from about 0.01% to about 1%, or less than about 0.5%, or less than about 0.1% by weight synthetic pesticide. The pest control composition may be substantially free of synthetic pesticide.

The pest control composition may be for use on human skin and comprise from about 0.1% to about 45%, or from about 0.25% to about 35%, or from about 0.5% to about 30%, or from about 1% to about 25% of one or more arthropod repellents. Nonlimiting examples of arthropod repellents for use on human skin include N, N-Diethyl-meta-toluamide (DEET), 1-(1-Methylpropoxycarbonyl)-2-(2-hydroxyethyl) piperidine (Picaridin), and Ethyl butylacetylaminopropionate (IR3535).

The pest control composition may comprise one or more biopesticides. Nonlimiting examples of biopesticides include pyrethrum, rotenone, neem oil, and mixtures thereof.

The pest control composition may comprise from about 0.15% to about 15%, or from about 0.5% to about 15%, or from about 0.5% to about 10%, by weight of the composition of one or more active ingredients, where the active ingredient is an essential plant oil. The pest control composition may comprise one or more essential plant oils selected from the group consisting of corn mint oil, peppermint oil, spearmint oil, rosemary oil, thyme oil, citronella oil, clove oil, cinnamon oil, cedarwood oil, garlic oil, geranium oil, lemongrass oil, and mixtures thereof, preferably selected from the group consisting of corn mint oil, spearmint oil, rosemary oil, thyme oil, and mixtures thereof, more preferably selected from the group consisting of corn mint oil, rosemary oil, and combinations thereof. The one or more essential plant oils may be selected from the group consisting of corn mint oil, peppermint oil, spearmint oil, rosemary oil and mixtures thereof. The pest control composition may comprise two or more essential plant oils selected from the group consisting of corn mint oil, peppermint oil, spearmint oil, and rosemary oil.

### Surfactant

The pest control composition disclosed herein may be formulated with one or more surfactants. The pest control composition may comprise from about 0.01% to about 15%, or from about 0.1% to about 10%, or from about 1% to about 10%, or from about 1% to about 12.5%, or from about 1% to about 15%, or from about 1% to about 8% of one or more surfactants, preferably one or more anionic surfactants, more preferably sodium lauryl sulfate.

A sprayed drop of a pesticidal composition comprising an active agent is preferably able to wet a target surface and spread out or cover a target area to perform its intended function. A surfactant generally reduces the surface tension of the water on the surface of the spray drop by reducing the interfacial tension between the spray drop and target surface, e.g., exoskeleton of an arthropod. Surfactants also wet and disperse particles of active ingredient(s) in the composition prior to spraying, thereby enabling more uniform coverage and wetting of the target upon spraying. Surfactants may also function to emulsify active agents that are not easily solubilized in water, such as oils. Surfactants thus include various agents known to function as emulsifiers or wetting agents. Suitable surfactants include anionic surfactants, amphoteric surfactants, zwitterionic surfactants, nonionic surfactants, cationic surfactants, or mixtures thereof.

Anionic surfactants are surfactant compounds that contain a long chain hydrocarbon hydrophobic group in their molecular structure and a hydrophilic group, including salts such as carboxylate, sulfonate, sulfate or phosphate groups. The salts may be sodium, potassium, calcium, magnesium, barium, iron, ammonium and amine salts of such surfactants. Anionic surfactants include the alkali metal, ammonium and alkanol ammonium salts of organic sulfuric reaction products having in their molecular structure an alkyl or alkaryl group containing from about 8 to about 22 carbon atoms and a sulfonic or sulfuric acid ester group. Examples of such anionic surfactants include water soluble salts and mixtures of salts of alkyl benzene sulfonates having from about 8 to about 22 carbon atoms in the allyl group (e.g., linear alkyl benzene sulfonates, such as dodecylbenzene sulfonate and salts thereof), alkyl sulfates and alkali metal salts thereof (preferably those having from about 8 to about 22 carbon atoms in the alkyl group, e.g., sodium dodecyl/lauryl sulfate), alkyl ether sulfates having from about 8 to about 22 carbon atoms in the alkyl group and about 2 to about 9 moles of ethylene oxide (e.g., sodium laureth sulfate). Aryl groups generally include one or two rings, alkyl groups generally include from about 8 to about 22 carbon atoms, and ether groups generally comprise from about 1 to about 9 moles of ethylene oxide (EO) and/or propylene oxide (PO), preferably EO. Surfactants may include potassium oleate. A preferred anionic surfactant is sodium lauryl sulfate or SLS (also known as sodium dodecyl sulfate). The pest control composition may comprise from about 1% to about 10%, preferably from about 2% to about 8.5%, or from about 4% to about 8%, by weight of the composition of sodium lauryl sulfate.

Anionic surfactants also include fatty acids and salts thereof. Fatty acids and salts thereof are organic molecules comprising a single carboxylic acid moiety (carboxylate anion in salts) and at least 7 carbon atoms, or from about 11 to about 22 carbon atoms, or from about 12 to about 16 carbon atoms. The salts may be sodium, potassium, calcium, magnesium, barium, iron, ammonium and amine salts of fatty acids. The salts of fatty acids are also known as soaps. Fatty acid and the salts thereof may be linear, branched, saturated, unsaturated, cyclic, or mixtures thereof. Nonlimiting examples of fatty acids and salts thereof include octanoic acid, nonanoic acid, decanoic acid, lauric acid, myristic acid, palmitic acid, stearic acid, arachidic acid, behenic acid, lignoceric acid, myristoleic acid, palmitoleic acid, sapienic acid, oleic acid, elaidic acid, vaccenic acid, linoleic acid, linoelaidic acid, arachidonic acid, eicosapentaenoic acid, erucic acid, docosahexaenoic acid, the sodium, calcium, potassium or zinc salts thereof, or mixtures thereof.

Alternatively, the compositions may be substantially free of fatty acids, as a fatty acid may be difficult to solubilize in an aqueous composition. In particular, the compositions may be substantially free of lauric acid, oleic acid, stearic acid, or a combination thereof.

Additional suitable anionic surfactants include alkyl sulfosuccinates, alkyl ether sulfosuccinates, olefin sulfonates, alkyl sarcosinates, alkyl monoglyceride sulfates and ether sulfates, alkyl ether carboxylates, paraffinic sulfonates, acyl methyl taurates, sulfoacetates, acyl lactates, and sulfosuccinamides.

Amphoteric surfactants are surface active agents containing at least one anionic group and at least one cationic group and may act as either acids or bases, depending on pH. Some of these compounds are aliphatic derivatives of heterocyclic secondary and tertiary amines, in which the aliphatic substituent(s) may be straight or branched, at least one of the aliphatic substituents contains from about 6 to about 20, or from about 8 to about 18, carbon atoms, and at least one of the aliphatic substituents contains an anionic water-solubilizing group, e.g., carboxy, phosphonate, phosphate, sulfonate, sulfate.

Zwitterionic surfactants are surface active agents having a positive and negative charge in the same molecule, where the molecule is zwitterionic at all pHs. Zwitterionic surfactants include betaines, sultaines, and lecithins. The zwitterionic surfactants generally contain a quaternary ammonium, quaternary phosphonium, or a tertiary sulfonium moiety. Zwitterionic surfactants contain at least one straight chain or branched aliphatic substituent, which contains from about 6 to 20, or from about 8 to about 18, carbon atoms, and at least one aliphatic substituent containing an anionic water-solubilizing group, e.g., carboxy, sulfonate, sulfate, phosphate or phosphonate.

Examples of suitable amphoteric and zwitterionic surfactants include the alkali metal, alkaline earth metal, ammonium or substituted ammonium salts of alkyl amphocarboxyglycinates and alkyl amphocarboxypropionates, alkyl amphodipropionates, alkyl monoacetate, alkyl diacetates, alkyl amphoglycinates, and alkyl amphopropionates, where the alkyl group has from 6 to about 20 carbon atoms. Other suitable amphoteric and zwitterionic surfactants include alkyliminomonoacetates, alkyliminidiacetates, alkyliminopropionates, alkyliminidipropionates, and alkylamphopropylsulfonates, where the alkyl group has from about 12 to about 18 carbon atoms, as well as alkyl betaines, alkylamidoalkylene betaines, alklyl sultaines, and alkylamidoalkylenehydroxy sulfonates.

The nonionic surfactant(s) may be any of the known nonionic surfactants, examples of which include condensates of ethylene oxide with a hydrophobic moiety. Nonionic surfactants include ethoxylated primary or secondary aliphatic alcohols having from about 8 to about 24 carbon atoms, in either straight or branch chain configuration, with from about 2 to about 40, or from about 2 and about 9 moles of ethylene oxide per mole of alcohol. Other suitable nonionic surfactants include the condensation products of alkyl phenols having from about 6 to about 12 carbon atoms with about 3 to about 100, or 3 to about 60, or 3 to about 30, or about 5 to about 14 moles of ethylene oxide. Nonionic surfactants also include ethoxylated castor oils and silicone surfactants, such as Silwet L-8610, Silwet L-8600, Silwet L-77, Silwet L-7657, Silwet L-7650, Silwet L-7607, Silwet L-7604, Silwet L-7600, and Silwet L-7280. Nonionic surfactants also include glyceryl esters, such as polyglyceryl oleate/stearate.

The pest control compositions of the present disclosure may optionally comprise one or more cationic surfactants. Suitable cationic surfactants include quaternary ammonium surfactants and amino surfactants that are positively charged at the pH of the pest control composition.

The weight ratio of surfactant, preferably anionic surfactant, more preferably sodium lauryl sulfate, to active ingredient is from about 1:3 to about 30:1, or about 1:3 to about 20:1, or about 1:1 to about 20:1, or about 1:1 to about 10:1, or about 1:3 to about 3:1, or about 1:2 to about 2:1, or about 1:1.5 to about 1.5:1, or about 1:1.2 to about 1.2:1. The weight ratio of surfactant, preferably anionic surfactant, more preferably sodium lauryl sulfate, to lemongrass oil may be about 1:1 to about 30:1 or about 2:1 to about 30:1. The weight ratio of surfactant, preferably anionic surfactant, more preferably sodium lauryl sulfate, to active ingredient, preferably an essential oil or a constituent thereof, may be from about 1:1 to about 30:1 or about 1:1 to about 20:1.

### Solvent

The pest control compositions described herein may comprise from about 0.05% to about 45%, or from about 0.1% to about 30%, or from about 1% to about 25%, or from about 1% to about 15%, or from about 8% to about 20% by weight the composition of one or more solvents. Liquid pest control compositions may contain one or more solvents and water.

Suitable solvents include alcohols, such as monohydridic or polyhydridic alcohols. Preferred monohydridic alcohols are low molecular weight primary or secondary alcohols exemplified by ethanol, propanol, and isopropanol, preferably isopropanol. Polyhydridic alcohols, such as those containing from 2 to about 6 carbon atoms and from 2 to about 6 hydroxy groups (e.g., ethylene glycol, glycerine, and 1,2-propanediol (also referred to as propylene glycol)), may also be used.

Suitable solvents also include esters. The pest control composition may comprise from about 0.005% to about 15%, or from about 0.05% to about 12%, or from about 0.5% to about 10%, or from about 1% to about 7% by weight of the composition of one or more esters. Examples of suitable esters include triethyl citrate, diethyl citrate, monoethyl citrate, isopropyl myristate, myristyl myristate, isopropyl palmitate, octyl palmitate, isopropyl isothermal, butyl lactate, ethyl lactate, butyl stearate, triethyl citrate, glycerol monooleate, glyceryl dicaprylate, glyceryl dimyristate, glyceryl dioleate, glyceryl distearate, glyceryl monomyristate, glyceryl monooctanoate, glyceryl monooleate, glyceryl monostearate, decyl oleate, glyceryl stearate, isocetyl stearate, octyl stearate, putty stearate, isostearyl neopentonate, PPG myristyl propionate, diglyceryl monooleate, and diglyceryl monostearate. The pest control composition may comprise triethyl citrate, preferably from about 0.005% to about 15%, or from about 0.05% to about 12%, or from about 0.5% to about 10%, or from about 1% to about 7% by weight of the composition of triethyl citrate.

Additional solvents include lipophilic fluids, including siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, and mixtures thereof.

Suitable solvents listed under section 25(b) of the Federal Insecticide, Fungicide, and Rodenticide Act (FIFRA) include butyl lactate (including enantiomers thereof), vinegar, 1,2-propylene carbonate, isopropyl myristate, ethyl lactate (including enantiomers thereof), and glycerine.

Preferred solvents include isopropanol, triethyl citrate, ethanol, glycerine, ethyl lactate, renewable versions thereof, and mixtures thereof. The pest control compositions described herein may comprise from about 1% to about 45%, or from about 1% to about 30%, or from about 1% to about 25%, or from about 1% to about 15% by weight the composition of a solvent selected from the group consisting of isopropanol, triethyl citrate, and mixtures thereof. The pest control compositions described herein may comprise from about 8% to about 20% by weight the composition of isopropanol. The pest control compositions described herein may comprise from about 0.3% to about 5%, preferably from about 0.3% to about 3% by weight the composition of glycerine.

### pH Adjusting Agents

The pest control compositions may comprise from about 0.00001% to about 1.5%, preferably from about 0.0001% to about 1%, more preferably from about 0.001% to about 0.8%, even more preferably from about 0.01% to about 0.6%, by weight of the composition of a pH adjusting agent, such as a carboxylic acid or a salt thereof selected from the group consisting of citric acid or a salt thereof, malic acid or a salt thereof, acetic acid or a salt thereof, fumaric acid or a salt thereof, humic acid or a salt thereof, and mixtures thereof, preferably citric acid or a salt thereof, more preferably citric acid anhydrous or citric acid monohydrate. The compositions described herein may comprise from about 0.00001% to about 1.5% by weight of the composition of citric acid or a salt thereof, such as sodium citrate, monosodium citrate, disodium citrate, trisodium citrate, trisodium citrate dihydrate, potassium citrate, monopotassium citrate, tripotassium citrate, tripotassium citrate monohydrate, or dipotassium citrate. Carboxylic acids, such as citric acid, or salts thereof may function to adjust the pH of the composition and/or as a chelant.

The pest control compositions may be subject to fluctuating temperatures during shipping, storage, and/or use. The pest control compositions are preferably stable at low temperatures (i.e., from about 5° C. to about 10° C.). “Stable” may refer to a pest control composition that is substantially clear and free from phase separation or precipitation, where no agitation or mixing is required to use the composition for its application.

Without being bound by theory, it is believed that the dispensing devices disclosed herein are particularly advantageous for the targeted spraying of pest control compositions ((e.g., insecticide or herbicide) from a distance of about 0.3 m to about 1.5 m, preferably about 0.3 m to about 1 m, from the target pest or surface. The composition (including characteristics such as viscosity and surface tension), the dispensing pressure, and/or the nozzle design may be selected to provide optimal spray exit velocity and particle size distribution (PSD) for spraying a pest control product on the target pest or surface at a distance of about 0.3 m to about 1.5 m, preferably about 0.3 m to about 1 m, from the target pest or surface.

The aerosol product may comprise a pest control composition comprising: (a) from about 0.5% to about 12%, preferably about 1% to about 10%, more preferably about 2% to about 8.5%, even more preferably about 3% to about 7.5%, by weight of the composition of sodium lauryl sulfate; (b) from about 0.5% to about 15%, preferably about 1% to about 10%, more preferably about 1.5% to about 8%, by weight of the composition of an active ingredient selected from the group consisting of cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, and mixtures thereof, preferably selected from the group consisting of geraniol, cornmint oil, peppermint oil, rosemary oil, lemongrass oil, and mixtures thereof; and (c) from about 60% to about 90%, preferably about 65% to about 85%, more preferably about 70% to about 80%, by weight of the composition of water.

The pest control composition may optionally further comprise from about 0.5% to about 10%, preferably from about 1% to about 5%, by weight of the composition of by weight of the composition of urea. The pest control composition may optionally further comprise from about 0.1% to about 45%, preferably from about 0.5% to about 35%, more preferably from about 1% to about 25%, even more preferably from about 2% to about 20%, by weight of the composition of by weight of the composition of a solvent selected from the group consisting of isopropyl alcohol, triethyl citrate, isopropyl myristate, ethyl lactate, butyl lactate, butyl stearate, glycerin, and mixtures thereof, preferably selected from the group consisting of isopropyl alcohol, triethyl citrate, and mixtures thereof. The pest control composition may also optionally further comprise a carboxylic acid or salt thereof selected from the group consisting of citric acid or a salt thereof, malic acid or a salt thereof, acetic acid or a salt thereof, fumaric acid or a salt thereof, humic acid or a salt thereof, and mixtures thereof, preferably citric acid or a salt thereof. The pest control composition may also optionally further comprise an ingredient selected from pH adjusting agents, propellants, preservatives, thickeners, fatty acids or salts thereof, and combinations thereof.

The pest control composition may be an oil-in-water emulsion. The pest control composition may have a turbidity less than about 20 NTU, a b* value of about 0 to about 5, or a combination thereof. The pest control composition may have a pH ranging from about 3.0 to about 11.0, or from about 4.0 to about 11.0, or from about 4.0 to about 9.0, or from about 5.0 to about 9.0, or from about 5.0 to about 8.0, or from about 6.0 to about 8.0, or from about 6.0 to about 7.0.

The pest control composition may be a “low VOC” composition and comprise about 3% volatile organic compounds (VOCs) by weight or less. Alternatively, the pest control composition may comprise greater than 3% volatile organic compounds (VOCs) by weight. The pest control composition may comprise greater than 3% to about 35% by weight of volatile organic compound (VOC). It may be desirable to keep the total level of VOCs in the pest control composition to less than or equal to about 3% by weight. VOCs can be measured according to the California Air Resources Board (CARB) Method 310 for VOC determination (May 25, 2018).

### Methods for Controlling Weeds

The present invention also relates to methods for controlling undesired weeds. In some aspects, the method for controlling weeds can comprise the steps of: (a) providing a pest control composition (e.g., an herbicide composition); and (b) contacting the weeds with an effective amount of the pest control composition. The pest control composition may be applied (e.g., by spraying as an aqueous liquid) onto a target area in an amount in the range of from about 0.5 to about 40 ml/ft, alternatively from about 0.9 to about 36 ml/ft.

The pest control composition, e.g., herbicide, may be used to inhibit the growth and/or development of weeds, such as for example dandelion, milk thistle, broadleaf plantain, white clover, green foxtail, redroot pigweed, yellow nutsedge, crabgrass, evening primrose, chickweed, common bermudagrass, morning glory, wild carrot, Italian ryegrass, umbrella sedge, or ivy. The pest control composition, e.g., herbicide, may be sprayed onto the leaves of target weeds. The pest control composition, e.g., herbicide, may be used to treat existing weeds or may be used prevent weed growth. In the latter case, the pest control composition, e.g., herbicide, may be used as a pre-emergent pest control.

The pest control composition, e.g., herbicide, may be used to control weeds that grow from a variety of surfaces. For example, the pest control composition, e.g., herbicide, may be sprayed on hard surfaces with openings containing dirt where weeds may be present or may develop, such as asphalt, concrete, interlocking bricks, roads, and highways. The pest control composition, e.g., herbicide, may be applied to lawns, golf course greens, or flower beds, where weeds may be present or may develop.

The pest control composition, e.g., herbicide, may be applied as a single treatment or as multiple treatments, such as application on consecutive days or weeks.

### Method of Controlling an Arthropod Pest

The present invention also relates to methods for controlling undesired arthropods, such as insects. In some aspects, the method of controlling an arthropod pest may comprise the steps of: i) providing a pest control composition (e.g., an insecticide composition); ii) contacting the arthropod pest with the pest control composition(s) as described herein; iii) optionally wiping any excess pest control composition from an adjacent surface(s). The arthropod pest may be contacted with an effective amount of the pest control composition. The optional wiping of an adjacent surface(s) may provide a cleaning benefit on the surface, due to the presence of a surfactant, such as sodium lauryl sulfate, in the composition. Optionally, the adjacent surface may be left to dry, without wiping or rinsing.

The pest control composition, e.g., insecticide, may be applied as a single treatment or as multiple treatments, such as application on consecutive days or weeks.

### Method of Repelling an Arthropod Pest

The present invention also relates to methods for repelling undesired arthropods, such as insects. In some aspects, the method of repelling an arthropod pest may comprise the steps of: i) providing a pest control composition (e.g., an insect repellent composition); ii) contacting a target surface with the pest repelling composition(s) as described herein; iii) optionally wiping any excess pest repellent composition from the target surface or adjacent surface(s). The target surface may be human skin or clothing and the insect repellent an on-body repellent designed to keep arthropod pests, such as mosquitoes, away from a human. The target surface may be a surface outside, inside or around a dwelling such as baseboards, indoor floors such as hard wood floors and concrete garage floors, outdoor floors such as patios and decks, windowsills, door sills, and countertops. The arthropod repelling composition may prevent or deter arthropods from crossing the barrier and entering unwanted areas. The optional wiping of the target or adjacent surface(s) may spread the arthropod repelling composition to provide better coverage or aid in the liquid composition drying faster. Optionally, the adjacent surface may be left to dry, without wiping or rinsing.

The pest repelling composition may be applied as a single treatment or as multiple treatments, such as application on consecutive days or weeks.

### Test Methods

### Brookfield Viscosity

Brookfield viscosity is measured at 23° C.±2° C. using a Brookfield DV-E viscometer. The liquid is contained in a glass jar, where the width of the glass jar is from about 5.5 to 6.5 cm and the height of the glass jar is from about 9 to about 11 cm using spindle LV2 at 60 RPM. The test is conducted in accordance with the instrument's instructions.

### pH Test Method

pH can be measured using a standard pH meter such as, for example, a Beckman Coulter model PHI1410 pH meter equipped with a general-purpose probe (manufactured by Beckman Coulter, Brea, California, U.S.A.). The pH meter is calibrated according to the manufacturer's instructions. Measurements are performed after storing the compositions at room temperature (approximately 23° C.±2° C.) for approximately 24 hours.

### Particle Size Test Method

Particle size is measured by light scattering data techniques. Particle size is determined with a Malvern Zetasizer Nano ZSP (Malvern Panalytical, Malvern, United Kingdom), or the like. The software used for control of the instrument and for data acquisition is the Malvern Zetasizer Software version 8.01.4906 (Malvern Panalytical). All samples are kept at 25° C., unless otherwise specified.

Samples are measured in BRAND® polystyrene disposable cuvettes (Cat. No. 759070D or equivalent). 1 mL of the sample is added into the cuvette using a disposable transfer pipette (VWR, Cat. No. 414004-004 or equivalent), swirled, and then discarded. Another 1 mL of the sample is added into the cuvette using a disposable transfer pipette. The cap is placed on the cuvette and all sides of the cuvette are wiped with lint-free lens paper. The cuvette is loaded into the instrument in accordance with the manufacture's specification to ensure light is passing correctly into the sample during the measurement, and the lid is closed.

The instrument is readied in accordance with manufacture's specification. The particle size measurements are made through the software with the following settings:

1) Under the ‘Measure’ section, the ‘Manual’ option is selected. ‘Measurement Type’ is then set to ‘Size’.

2) The ‘Sample’ section is then selected. In the ‘Material’ subsection: ‘Material’ is chosen to be ‘SDS’; the ‘RI’ is set to 1.461; and the ‘Absorption’ is set to 0.001. In the ‘Dispersant’ subsection: ‘Dispersant’ is selected as ‘Water’; ‘Temperature’ is set to 25.0 deg C.; ‘Viscosity’ is set at 0.8872 cP; and ‘RI’ is set as 1.330. In the ‘General options’ subsection ‘Mark-Houwink Parameters’ is selected, ‘A Parameter’ is set to 0.428; and ‘K Parameter (cm2/s)’ is set to 7.67e-05. In the ‘Temperature’ subsection: ‘Temperature’ is set as 25.0 deg C.; ‘Equilibration Time (second)’ is set to 120. In the ‘Cell’ subsection: ‘Cell Type’ is selected to be ‘Disposable cuvettes’; and the ‘DTS0012’ option is selected.

3) The ‘Measurement’ section is then selected. The ‘Angle of Detection Measurement Angle’ is selected as ‘173o Backscatter (NIBS default)’; ‘Measurement Duration’ is selected as ‘Automatic’; ‘Number of Runs’ is set to 11; ‘Run duration (seconds)’ is set to 10; ‘Number of Measurements’ is set as 3; ‘Delay between Measurements (seconds)’ is set to 0; ‘Append Measurement Number to Sample Name’ is selected; and ‘Allow Results to be Saved Containing Correlation Data Only’ is not selected. In the ‘Advanced’ subsection: ‘Measurement duration, Extend Duration for Large Part’ is set to ‘No’; ‘Measurement settings, Positioning method’ is set to ‘Seek for Optimum Position’; and Automatic attenuation selection is set to ‘Yes’.

4) The ‘Data Processing’ section is then selected, and the following options are selected: ‘Analysis Model’ is selected as ‘General Purpose (Normal Resolution)’. The ‘Size Analysis Parameters’ are set to: ‘Analysis Details’; ‘Name’ is set to ‘Customized’, ‘Description’ is set to ‘Customized Analysis’; ‘Display Range’ is set with the ‘Lower Limit’ set to 0.6 and ‘Upper Limit’ set to 6000; ‘Multimodal-analysis, Resolution’ is selected to ‘Normal’; ‘Size classes, Number of size classes’ is Set AS 70; ‘Lower Size Limit’ is set as 0.4; ‘Upper Size Limit’ is set as 10,000; ‘Lower Threshold’ is set as 0.05; and ‘Upper Threshold’ is set as 0.01. In the ‘Reports’ subsection: ‘Print Report’ is not selected and in the ‘Export’ subsection: ‘Export’ results is not selected.

### Spray Droplet Size Test Method

The term “Dv10 value” describes the average particle size where 10 vol. % of the particles have a smaller size. Similarly, the term “Dv50 value” describes the average particle size where 50 vol. % of the particles have a smaller size, and the term “Dv90 value” describes the average particle size where 90 vol. % of the particles have a smaller size. The Sauter mean diameter (D[3, 2]) is the weighted average surface diameter, assuming spherical particles of the same surface area as the actual particles:

$$D [ 3 , 2 ] = \frac{\begin{matrix}\sum {D}_{i}^{3} & {n}_{i}\end{matrix}}{\begin{matrix}\sum {D}_{i}^{2} & {n}_{i}\end{matrix}} .$$

Spray droplet volume size distribution measurements comprising Spray D(50) Normalized, Spray D(90) Normalized, and Spray D(2,3) Normalized values are determined using a Malvern Spraytec 2000 laser diffraction spray droplet sizing instrument (supplied by Malvern Instruments, Worcestershire, UK), equipped with a 300 mm lens possessing a focal length of the 150 mm, and an Air Purge System (not greater than 14.5 psi). The system is controlled with a computer and software accompanying the instrument, such as the Spraytec software version 3.20 or equivalent, utilizing Mie Theory and Fraunhofer Approximation optical theory. The system is placed in a fume hood for atmospheric control with care taken to place it directly opposite the actuation spray plume trajectory to prevent saturation, with an air flow rate of between 50-70 L/min (60 L/min was the target rate). The distance from the dispensing nozzle orifice to the laser during measurements is 30 cm. A new spray bottle is used for each sample replicate analyzed. Lighting conditions are not changed during or between the background control and test sample data collection periods. Light obscuration values below 95% are considered suitable to provide accurate results.

Samples analyzed included “example” samples, which are samples according to this disclosure, and comparative samples. All newly created example samples are tested within three hours of preparation and are measured at temperatures between 20-22° C. Deionized water is used as a standard reference spray and is labeled as the “control.”

Spray measurements are conducted using the following spray SOP instrument configuration: Rapid SOP type is chosen, and the following settings are selected: Hardware Configuration is set to “Default”, Measurement Type is set to “Rapid”, Data Acquisition Rate is set to “250 Hz”, and Lens Type is set to “300”. Within the Measurement menu: Background is set to “3 seconds”, Inspection is selected, the box under Output Trigger is Unchecked. Under the Measurement tab “Rapid” is selected, Events Number is set to “1”, Duration Per Event is set to “4000.0”, Units is set to “ms”. Measurement Trigger where Trigger Type is set to “Transmission drops to level” and Transmission is set to “96”, Data Collection where Start is set to “52”, Units is set to “ms”, and select “before the trigger” from the drop down menu. On the Advanced tab window, all boxes are Unchecked, and Grouping is “no grouping”; The Background Alarms are set to “default values”. On the Analysis Tab and under Optical Properties, Particle Set is set to “Water”, Dispersant set to “Air”, Multiple Scattering Analysis is set to “Enable”. On the Data Handling tab and under Detector Range is set to “first: 1 and last: last”, “No extinction analysis” box is selected, Scattering threshold is set to “1”. On the Data Handling/Spray Profile the Path Length is set to “100.0”, the Alarm is selected, and the “Use default values” box is checked. On the Additional Properties tab the Curve Fit is set to “no fit”, User Size is set to “enable box”, the drop down menu is set to “Default”. On the Additional Properties/Advanced tab Particle Diameter is set to “0.10” for the minimum and to “900” for the maximum, and Result Type is set to “Volume Distribution”. On the Output tab, Export Option is set to “not selected”, the Derived Parameter is selected, the Use Averaging Period box is selected and set to “0.0” and “ms”. On the Average menu “Average scatter data” is selected.

Spray measurements are conducted using the following Spray Procedure: The sample is first test sprayed from the spray bottle for 1-2 seconds, to ensure that the nozzle is free flowing and not clogged; the sample is loaded into the holding device in the front of the Spraytec 2000 system. The actuator is fully depressed. The spray droplet size data are viewed and saved as “Average Scatter Data”.
a. The value obtained from each sample measurement is normalized to the control sample value in accordance with the following calculations:

$$\begin{matrix}The value of Spray D ( 50 ) Normalized = {D ( 50 )}_{E x a m p l e} / {D ( 50 )}_{Control} ; \\ The value of Spray D ( 90 ) Normalized = {D ( 90 )}_{E x a m p l e} / {D ( 90 )}_{Control} ; \\ The value of Spray D ( 3 , 2 ) Normalized = {D ( 3 , 2 )}_{E x a m p l e} / {D ( 3 , 2 )}_{Control} ;\end{matrix}$$

wherein:

Spray D(50), Spray D(90), and Spray D(3,2) are values obtained from the instrument software for both the example samples and control samples separately.

Each of the Spray D(90) Normalized and Spray D(3,2) Normalized values reported for each of the samples is the average value calculated from five replicate spray plumes per sample.

### Determination of the Hunter L.a.b. (CIE) b* Value

The formation of yellow color is measured using the Hunter L.a.b. (CIE) method. The b* value is determined using a HunterLab ColorFlex EZ® spectrophotometer (HunterLab, 11491 Sunset Hills Road, Reston, Virginia 20190). The methodology that is used is described in detail in the “User's Manual for ColorFlex EZ Version 2.2.”

The HunterLab ColorFlex EZ® spectrophotometer uses a xenon flash lamp to illuminate a sample. The light reflected from the sample is then separated into its component wavelengths through a dispersion grating. The relative intensities of the light at different wavelengths along the visible spectrum (400-700 nm) are then analyzed to produce a number result indicative of the color of the sample.

### Turbidity Method

A turbidimeter is used to measure the turbidity of the compositions. This instrument measures the turbidity of liquids in Nephelometric Turbidity Units (NTU). The method of measuring turbidity is described in detail in the following reference: Hach 2100Q and 2100Q is User Manual, Edition 6, August 2021, from the Hach Company. If a sample is not homogenous prior to analysis, the sample is inverted until it appears homogenous and is then poured into an analyte vile for measurement.

This method of measurement determines quantitative values of turbidity by evaluating the ratio of a primary nephelometric light scatter signal to a transmitted light scatter signal. This particular method of evaluation provides values between 0-1000 NTU, where increasing NTU values indicate more turbid compositions. In between each test sample, water controls may be measured to ensure proper equipment operation. For example, water may have a turbidity of about 1.11 NTU and isopropyl alcohol may have a turbidity of about 0.15 NTU. It is believed that improved emulsification of active ingredients, particularly hydrophobic active ingredients, yields lower NTU values.

### Surface Tension Method

Surface tension is measured according to ASTM 1331-14 (Published January 2015) using an EZ-Pi tensiometer (Kibron, Parrish, Fla.), or equivalent. The instrument is calibrated according to the manufacturer instructions using DI water. Measurements are taken and values are reported in mN/m.

### Temperature Stability Method

Samples are prepared by combining all composition ingredients in a 4-ounce glass vial at ambient conditions (25 deg. C.). The sample is mixed and, five minutes after mixing is completed, the sample is observed for initial stability.

Cold temperature cycle stability is measured by filling a 4-ounce glass vial with a sample composition. The vial is sealed and stored at 5° C. for 12 to 14 hours. The vial is then moved to a 25° C. environment and stored for 10 to 12 hours, thereby completing one cold temperature cycle. This is repeated two more times, for a total of three cold temperature cycles. After the final incubation at 25° C., the vials are visually observed for stability (and may be assessed for turbidity and b* value using the Turbidity and Hunter L.a.b. (CIE) method described above).

### EXAMPLES

The following data and examples are provided to help illustrate the pest control compositions and arrays of pest control products described herein. The exemplified compositions are given solely for the purpose of illustration and are not to be construed as limitations of the present invention, as many variations thereof are possible without departing from the spirit and scope of the invention. All parts, percentages, and ratios herein are by weight unless otherwise specified. Example formulations are made by mixing ingredients together under ambient conditions.

A composition in the array may be an insecticide spray. Non-limiting examples of insecticide spray compositions are shown in Table 1.

TABLE 1

| Ingredient (wt | | | | | | | |
|---|---|---|---|---|---|---|---|
| percent) | I1 | I2 | I3 | I4 | I5 | I6 | I7 |
| Water | QS | QS | QS | QS | QS | QS | QS |
| Potassium Citrate | 0.92 | 0.92 | 0.92 | 0.92 | 0.92 | 0.92 | 0.92 |
| Potassium Sorbate | 0.4 | 0.4 | 0.4 | 0.4 | 0.4 | 0.4 | 0.4 |
| Sodium Lauryl Sulfate | 12 | 6 | 0.5 | 5 | 5 | 8.5 | 6 |
| Cornmint Oil | 2.5 | 2.5 | 2.5 | 0.05 | 2.5 | 2.5 | 2.5 |
| Rosemary Oil | 2.5 | 2.5 | 2.5 | 0.05 | 2.5 | 2.5 | 2.5 |
| Isopropyl Alcohol | 0.5 | 16.6 | 16.6 | 16.6 | 16.6 | 16.6 | 2.5 |
| Glycerin | 2.5 | 2.5 | 2.5 | 2.5 | 2.5 | 2.5 | 2.5 |
| Citric Acid | adjust | adjust | adjust | adjust | adjust | adjust | adjust |
| | to pH | to pH | to pH | to pH | to pH | to pH | to pH |
| | 7-8 | 7-8 | 7-8 | 7-8 | 7-8 | 7-8 | 7-8 |

The composition in the array may be an herbicide composition. Non-limiting examples of herbicide compositions are shown in Table 2.

TABLE 2

| Ingredient | | | | | | | | |
|---|---|---|---|---|---|---|---|---|
| (wt percent) | H1 | H2 | H3 | H4 | H5 | H6 | H7 | H8 |
| Sodium Lauryl | 6.50 | 6.50 | 6.50 | 6.50 | 6.50 | 6.50 | 6.50 | 6.50 |
| Sulfate | | | | | | | | |
| Citric Acid | adjust | adjust | adjust | adjust | adjust | adjust | adjust | adjust |
| | to pH | to pH | to pH | to pH | to pH | to pH | to pH | to pH |
| | 6-7 | 6-7 | 6-7 | 6-7 | 6-7 | 6-7 | 6-7 | 6-7 |
| Isopropyl | 2.70 | 2.85 | 2.70 | 2.50 | 1.50 | 1.80 | 1.65 | 1.50 |
| Alcohol | | | | | | | | |
| Geraniol | 4.85 | 2.85 | 3.85 | 3.35 | 4.35 | 2.35 | 1.85 | 1.35 |
| Corn Mint Oil¹ | 1.00 | 1.00 | 0.50 | 1.00 | 1.00 | 1.00 | 1.00 | 0 |
| Peppermint | 0 | 1.50 | 0.50 | 0 | 0 | 0.50 | 1.00 | 0.50 |
| Organic Oil² | | | | | | | | |
| Peppermint | 0 | 0 | 0 | 0 | 0 | 0.50 | 1.00 | 0.50 |
| Yakima | | | | | | | | |
| Redistilled | | | | | | | | |
| Peppermint | 0 | 0 | 0 | 0 | 0 | 0 | 0.50 | 1.50 |
| Indian Oil | | | | | | | | |
| Spearmint | 0 | 0 | 0 | 0.50 | 0.50 | 0.50 | 0.50 | 1.00 |
| Chinese Oil | | | | | | | | |
| Citronella | 0 | 0.50 | 1.00 | 1.00 | 0 | 1.00 | 0 | 1.00 |
| Java Oil | | | | | | | | |
| Triethyl citrate | 6.5 | 6.0 | 6.5 | 6.5 | 6.5 | 6.0 | 6.0 | 6.0 |
| Sodium Citrate | 0.25 | 0.25 | 0.25 | 0.25 | 0.25 | 0.25 | 0.25 | 0.25 |
| Water | QS | QS | QS | QS | QS | QS | QS | QS |
| Urea | 5.0 | 4.0 | 3.0 | 2.0 | 1.0 | 2.0 | 1.0 | 5.0 |

The composition may be a pest repelling composition. Non-limiting pest repelling compositions are shown in Table 3.

TABLE 3

| | R1 | R2 | R3 | R4 | R5 | R6 | R7 | R8 | R9 |
|---|---|---|---|---|---|---|---|---|---|
| Sodium Octanoate | 1.0 | 1.0 | 1.0 | 1.0 | 1.0 | 1.0 | 1.0 | 1.0 | 1.0 |
| Oleic Acid | 0.15 | 0.15 | 0.15 | 0.15 | 0.15 | 0.15 | 0.15 | 0.15 | 0.15 |
| Sodium Lauryl Sulfate | 3.5 | 3.5 | 3.5 | 3.5 | 3.5 | 3.5 | 3.5 | 3.5 | 3.5 |
| Citric Acid | 2.4 | 2.4 | 2.4 | 2.4 | 2.34 | 0.68 | 1.85 | 0.64 | 0.26 |
| Sodium Citrate | 0.92 | 0.92 | 0.92 | 0.92 | 0.92 | 0.25 | 0.92 | 0.13 | 0.25 |
| Triethyl Citrate | 5.0 | 5.0 | 5.0 | 2.4 | 2.4 | 2.4 | 2.4 | 0.60 | 2.4 |
| Cornmint Oil | 2.0 | 0 | 3.0 | 1.2 | 1.26 | 1.26 | 1.26 | 1.26 | 1.26 |
| Rosemary Oil | 0 | 0 | 0 | 0.8 | 0.80 | 0.80 | 0.80 | 0.80 | 0.80 |
| Peppermint Oil | 0 | 0 | 0 | 0.2 | 0.14 | 0.14 | 0.14 | 0.14 | 0.14 |
| Isopropanol alcohol | 13.0 | 13.0 | 13.0 | 13.0 | 13.0 | 13.0 | 7.5 | 7.5 | 13.0 |
| Glycerin | 0.5 | 0.5 | 0.5 | 0.5 | 0.5 | 0.5 | 0.5 | 0.5 | 0.5 |
| Water | QS | QS | QS | QS | QS | QS | QS | QS | QS |

Non-liming examples of arrays of pesticidal products are described in Table 4.

TABLE 4

| | A1 | A2 | A3 | A4 | A5 | A6 | A7 |
|---|---|---|---|---|---|---|---|
| First | Crawling | Arthropod | Crawling | Arthropod | Herbicide | Insecticide | Herbicide |
| Product | insecticide | repellent | insecticide | repellent | | | |
| First | Inverted | Inverted | Inverted | Inverted | Inverted | Inverted | Inverted |
| Package | Aerosol | Aerosol | Aerosol | Aerosol | Aerosol | Aerosol | Aerosol |
| | (FIG. 3) | (FIG. 3) | (FIG. 3) | (FIG. 3) | (FIG. 3) | (FIG. 3) | (FIG. 3) |
| First | I2 | R2 | I6 | R5 | H5 | I5 | H5 |
| Formula | | | | | | | |
| Second | Flying | Flying | Herbicide | Herbicide | Insecticide | Arthropod | Herbicide |
| Product | insecticide | insecticide | | | | repellent | |
| Second | Trigger | Pump | Powered | Upright | Trigger | Powered | Powered |
| Package | Spray | Spray | Spray | Aerosol | Spray | Spray | Spray |
| | (FIG. 16) | (FIG. 17) | (FIG. 18) | | (FIG. 16) | (FIG. 18) | (FIG. 18) |
| Second | I5 | I3 | H2 | H1 | I4 | H3 | H6 |
| Formula | | | | | | | |

### Combinations

Various embodiments relate to:
1. An array of pesticidal products comprising:
   a. a first pesticidal product comprising an aerosol container comprising a reservoir, an actuator assembly comprising a resting plane such that the first pesticidal product may be shelved in an inverted orientation, and a first pesticidal composition stored within the first pesticidal product reservoir; and
   b. a second pesticidal product comprising a container comprising a reservoir, a nozzle and a second pesticidal composition stored within the second pesticidal product reservoir, wherein the second pesticidal product is shelved in an upright orientation.
2. The array of pesticidal products according to Paragraph 1, wherein the first pesticidal product is stored in an inverted orientation on a store shelf separate from the second pesticidal product that is stored in an upright orientation in a way that first and second pesticidal product packages are visible to a consumer during the consumer's purchasing decision process.
3 The array of pesticidal products according to Paragraphs 1 or 2, wherein the first and second pesticidal products are designed to be sold individually.
4. The array of pesticidal products according to any one of Paragraphs 1 to 3, wherein the first and second pesticidal products comprise a common brand name.
5. The array of pesticidal products according to any one of Paragraphs 1 to 4, wherein the first pesticidal product is an herbicide and the second pesticidal product is an insecticide or insect repellent.
6. The array of pesticidal products according to any one of Paragraphs 1 to 5, wherein the first pesticidal product is an insecticide for treating a crawling insect selected from the group consisting of ants, spiders, roaches, and combinations thereof; and wherein the second pesticidal product is an insecticide for treating flying insects selected from the group consisting of flies, moths, mosquitoes, and combinations thereof.
7. The array of pesticidal products according to any one of Paragraphs 1 to 6, wherein the first pesticidal product is an insecticide for repelling insects and wherein the second pesticidal product is an insecticide for killing insects upon contact.
8. The array of pesticidal products according to any one of Paragraphs 1 to 7, wherein the second pesticidal composition comprises an insect repellent selected from the group consisting of N,N-Diethyl-3-methylbenzamide (DEET), 1-piperidinecarboxylic acid 2-(2-hydroxyethyl)-1-methylpropylester (picaridin), Ethyl butylacetylaminopropionate (IR3535), and mixtures thereof.
9. The array of pesticidal products according to any one of Paragraphs 1 to 8, wherein the first pesticidal composition comprises an active selected from the group consisting of cornmint oil, spearmint oil, mint oil, geraniol, menthol, carvone, menthone, citronella and mixtures thereof; and the second pesticidal product is an insecticide and the second pesticidal composition comprises an active selected from the group consisting of cornmint oil, peppermint oil, spearmint oil, rosemary oil, thyme oil, citronella oil, clove oil, cinnamon oil, cedarwood oil, garlic oil, geranium oil, lemongrass oil, and mixtures thereof, preferably selected from the group consisting of corn mint oil, spearmint oil, rosemary oil, thyme oil, and mixtures thereof, more preferably selected from the group consisting of corn mint oil, rosemary oil, geraniol and combinations thereof.
10. The array of pesticidal products according to any one of Paragraphs 1 to 9, wherein the first pesticidal product has a VOC from about 5% to about 45% by weight of the first pesticidal composition and the second pesticidal product has a VOC from about 0.1% to about 3% by weight of the second pesticidal composition.
11. The array of pesticidal products according to any one of Paragraphs 1 to 10, wherein the first pesticidal composition comprises from about 5% to about 45% by weight of the first pesticidal composition of isopropyl alcohol and the second pesticidal composition comprises from 0% to about 3% by weight of the second pesticidal composition of isopropyl alcohol.
12. The array of pesticidal products according to any one of Paragraphs 1 to 11, wherein the first pesticidal product is an insect repellent and the first pesticidal composition comprises octanoic acid, and the second pesticidal product is a contact kill insecticide and the second pesticidal composition comprises an active selected from the group consisting of cornmint oil, peppermint oil, spearmint oil, rosemary oil, thyme oil, citronella oil, clove oil, cinnamon oil, cedarwood oil, garlic oil, geranium oil, lemongrass oil, and mixtures thereof, preferably selected from the group consisting of corn mint oil, spearmint oil, rosemary oil, thyme oil, and mixtures thereof, more preferably selected from the group consisting of corn mint oil, rosemary oil, geraniol and combinations thereof.
13. The array of pesticidal products according to any one of Paragraphs 1 to 12, wherein the first pesticidal product has a particle size distribution (PSD) DV90 of 400 microns to 900 microns when sprayed and the second pesticidal product has a PSD DV90 of 100 microns to 300 microns when sprayed.
14 The array of pesticidal products according to any one of Paragraphs 1 to 13, wherein the first and second reservoir are plastic and/or transparent.
15. The array of pesticidal products according to any one of Paragraphs 1 to 14, wherein the first pesticidal product discharges substantially parallel to a longitudinal axis of the reservoir and the second pesticidal product discharges substantially perpendicular to a longitudinal axis of the reservoir.
16. The array of pesticidal products according to any one of Paragraphs 1 to 15, wherein the second pesticidal product has a powered pump.
17. The array of pesticidal products according to any one of Paragraphs 1 to 16, wherein the first pesticidal product has a 2D indicia representing a plant and the second pesticidal product as a 2D indicia depicting an insect.
18. The array of pesticidal products according to any one of Paragraphs 1 to 17, wherein the first pesticidal product has a 2D indicia representing a crawling insect and the second insecticidal product has a 2D indicia depicting a flying insect.

### Further Definitions and Cross-References

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An array of pesticidal products comprising:
a. a first pesticidal product comprising an aerosol container comprising a reservoir, an actuator assembly comprising a resting plane such that the first pesticidal product may be shelved in an inverted orientation, and a first pesticidal composition stored within the first pesticidal product reservoir; and
b. a second pesticidal product comprising a container comprising a reservoir, a nozzle, and a second pesticidal composition stored within the second pesticidal product reservoir, wherein the second pesticidal product is shelved in an upright orientation.

2. The array of pesticidal products according to claim 1, wherein the first pesticidal product is stored in an inverted orientation on a store shelf separate from the second pesticidal product that is stored in an upright orientation in a way that first and second pesticidal product packages are visible to a consumer during the consumer's purchasing decision process.

3. The array of pesticidal products according to claim 1, wherein the first and second pesticidal products are designed to be sold individually.

4. The array of pesticidal products according to claim 1, wherein the first and second pesticidal products comprise a common brand name.

5. The array of pesticidal products according to claim 1, wherein the first pesticidal product is an herbicide and the second pesticidal product is an insecticide or insect repellent.

6. The array of pesticidal products according to claim 1, wherein the first pesticidal product is an insecticide for treating a crawling insect selected from the group consisting of ants, spiders, roaches, and combinations thereof; and wherein the second pesticidal product is an insecticide for treating flying insects selected from the group consisting of flies, moths, mosquitoes, and combinations thereof.

7. The array of pesticidal products according to claim 1, wherein the first pesticidal product is an insecticide for repelling insects, and wherein the second pesticidal product is an insecticide for killing insects upon contact.

8. The array of pesticidal products according to claim 1, wherein the second pesticidal composition comprises an insect repellent selected from the group consisting of N,N-Diethyl-3-methylbenzamide (DEET), 1-piperidinecarboxylic acid 2-(2-hydroxyethyl)-1-methylpropylester (picaridin), Ethyl butylacetylaminopropionate (IR3535), and mixtures thereof.

9. The array of pesticidal products according to claim 1, wherein the first pesticidal composition comprises an active selected from the group consisting of cornmint oil, spearmint oil, mint oil, geraniol, menthol, carvone, menthone, citronella and mixtures thereof; and the second pesticidal product is an insecticide and the second pesticidal composition comprises an active selected from the group consisting of corn mint oil, spearmint oil, rosemary oil, thyme oil, and mixtures thereof.

10. The array of pesticidal products according to claim 1, wherein the first pesticidal product has a VOC from about 5% to about 45% by weight of the first pesticidal composition, and the second pesticidal product has a VOC from about 0.1% to about 3% by weight of the second pesticidal composition.

11. The array of pesticidal products according to claim 1, wherein the first pesticidal composition comprises from about 5% to about 45% by weight of the first pesticidal composition of isopropyl alcohol, and the second pesticidal composition comprises from 0% to about 3% by weight of the second pesticidal composition of isopropyl alcohol.

12. The array of pesticidal products according to claim 1, wherein the first pesticidal product is an insect repellent and the first pesticidal composition comprises octanoic acid, and the second pesticidal product is a contact kill insecticide and the second pesticidal composition comprises an active selected from the group consisting of cornmint oil, peppermint oil, spearmint oil, rosemary oil, thyme oil, citronella oil, clove oil, cinnamon oil, cedarwood oil, garlic oil, geranium oil, lemongrass oil, and mixtures thereof.

13. The array of pesticidal products according to claim 1, wherein the first pesticidal product has a particle size distribution DV90 of from about 400 microns to about 900 microns when sprayed and the second pesticidal product has a particle size distribution of from about 100 microns to about 300 microns when sprayed.

14. The array of pesticidal products according to claim 1, wherein the first and second reservoir are plastic.

15. The array of pesticidal products according to claim 14, wherein the first and second reservoir are transparent.

16. The array of pesticidal products according to claim 1, wherein the first pesticidal product discharges substantially parallel to a longitudinal axis of the reservoir and the second pesticidal product discharges substantially perpendicular to a longitudinal axis of the reservoir.

17. The array of pesticidal products according to claim 1, wherein the second pesticidal product has a powered pump.

18. The array of pesticidal products according to claim 1, wherein the first pesticidal product has a 2D indicia representing a plant and the second pesticidal product as a 2D indicia depicting an insect.

19. The array of pesticidal products according to claim 1, wherein the first pesticidal product has a 2D indicia representing a crawling insect and the second insecticidal product has a 2D indicia depicting a flying insect.
